(19) United States
(12) Patent Application Publication
(10) Pub. No.: US 2002/0046046 A1
(43) Pub. Date: Apr. 18, 2002

(54) Computerized family advising system and method for making funeral arrangements

(76) Inventors: John Christopher Barrott, Cincinnati, OH (US); Nancy Kay Koors, Villa Hills, KY (US); Charles Earl Day JR., Aurora, IN (US)

Correspondence Address: Killworth, Gottman, Hagan & Schaeff, L.L.P., Suite 500, One Dayton Centre, Dayton, OH, 45402-2023, US

(21) Appl. No.: 09/897,723

(22) Filed: Jul. 2, 2001

Related U.S. Application Data
(63) Continuation-in-part of application No. 09/409,566, filed on Sep. 30, 1999.

(51) Int. Cl. G06F 17/60

(52) U.S. Cl. 705/1; 705/27

(57) ABSTRACT

A computerized family advising system and method for making funeral arrangements which permits families to gain knowledge about every aspect of the funeral arrangement process, and to view and order funeral products and services. The system is also designed to help funeral directors, through a virtual showroom, in both the planning of at-need or pre-need funeral services and the showing of an increased inventory of funeral products and/or service available from a distributor's remote database. The system is a browser-based computer application installed on a multimedia computer in a funeral home showroom, office or conference room. The system, if desirable, is accessible by users through the Internet using any standard Internet browser. The system is capable of both recognizing user-initiated events and accepting user data in order to take a defined action, returning funeral related information, and placing orders to the distributor's remote database.

### BACKGROUND OF THE INVENTION

1. Field of the Invention

The present invention relates to a family advising system and method for making funeral arrangements. More particularly, the present invention relates to a computer system and software for assisting in making selections of pre-need or at-need funeral services and products.

2. Description of Related Art

Each year, Americans arrange more than two million funerals for family and friends. As such, one of the greatest issues facing providers of funeral services is dealing with families or friends of the deceased person that know very little about the products and services available to them. Typically, families and friends are often burdened with arranging a funeral service during a very stressful period that sometimes offers little time for making informed decisions. Under such pressured circumstances, the families and friends may be unable to find reliable, unbiased information about the available funeral services and products. Because funerals can cost thousands of dollars and because dozens of unanticipated decisions must be made quickly, choosing only those goods and services wanted or needed may be frustrating to such uninformed families and friends.

In arranging funeral services, most families or friends of the deceased person either stop by a funeral home or shop by phone to compare prices among funeral providers. However, obtaining only price information is problematic. First, finding out the cost of products and services over the telephone or in person can be intimidating, thereby possibly adding more stress to the already grieving family or friend. Second, a family member or friend calling or visiting a funeral provider may forget to ask about other funeral options, the terms, the conditions, and even the prices of funeral goods and services. Third, price lists neither provide reasonable answers to the questions that uninformed families and friends should be asking about the available funeral services and products nor enable funeral providers to present death care information in a sensitive and caring environment. Fourth, due to limited floor space in a funeral home, funeral providers have to select and choose which products to display, thereby limiting the selection of products from which a family or friend may browse and choose.

Therefore, there is a need for a system and method that will provide death care information to families and friends in a sensitive and caring environment. Additionally, there is a need for a system and method that allows a funeral provider to inform families and friends about additional products not physical displayed on the showroom floor of the funeral home. Furthermore, there is a need for a system and method that will present funeral products in various theme arrangements in order to stimulate ideas for personalizing a funeral.

### SUMMARY OF THE INVENTION

The present invention provides a computerized family advising system and method for making funeral arrangements in which a user is guided though a series of interactive electronic multi-media pages in order to make decisions on funeral services and products desired. The series of interactive electronic pages also presents funeral products and services in themes in order to stimulate ideas for personalizing the funeral. Additionally, the interactive electronic pages allow the user to make further informational inquires about particular funeral services and products, and to complete an ordering request. At the completion of the funeral arrangement process, the ordering request is then forwarded to funeral services and products suppliers for processing.

One object of the present invention is to provide a system and method that give family members and friends of the deceased person all the options available to them in both arranging funeral services and selecting funeral products in a sensitive and caring environment.

Another object of the invention is to allow a funeral provider to inform families and friends in a sensitive, caring environment about the available funeral services, and additional products not physical displayed on the showroom floor.

Yet, another object of the present invention is to provide a system and method for managing an inventory of funeral products.

In order to achieve the foregoing objects, in a first instance, the present invention is a family advising computer system that presents an electronic home page and associated script files for making funeral arrangements. The computer system is configured to guide the user through the funeral planning process allowing the user to gain knowledge and to ask questions about several aspects of the funeral planning process before making planning decisions. Once the user has been guided through the planning process, a summary page is generated.

The summary page shows an itemized list of the items and prices of all the choices that the user has made in arranging the funeral services and products while being guided through the planning process. The user has the option to accept, change or not accept those arrangement choices. Additionally, the computer system is also designed to help funeral directors with the planning of at-need or pre-need funeral services by allowing them to present the funeral arrangement information in a caring and sensitive environment. The planning can take place with either as much or as little interaction desired by the user. Further, through a “virtual” showroom, the computer system is designed to allow funeral providers to display an increased inventory of funeral products in order to meet the needs of a family or friend of the deceased person. The “virtual” showroom in one embodiment, presents the funeral products and/or services arranged in a number of different themes to stimulate ideas for personalizing the funeral.

The family advisor computer system is a browser-based computer application that in one embodiment operates on a multimedia-computer. As such, a computer of the computer system may be preferably located in a funeral home showroom, office or conference room. In an alternative embodiment, the application can be loaded on a laptop computer for a funeral professional to present in a client's family home if desired. In still another embodiment, the application may operate on a web-server, and be accessible by users over a network using any standard Internet browser, such that the user can complete the funeral arrangement process via remote computers from the comforts of home.

The family advisor computer system is used either “pre-need” by a person making funeral arrangement before death or “at-need” by family members or friends for a deceased person. The family advisor computer system guides the user through a series of questions with choices to determine, generally, which services and products are of an interest to the individual. Additionally, the computer system provides a funeral provider with the ability to show and offer funeral products desired by the user without requiring the funeral home to maintain such products and services in an actual showroom (e.g., having caskets displayed) of the funeral home.

Through the family advisor computer system the user can view and select funeral arrangement options/services (e.g., burial, cremation, embalming, etc.) and products (e.g., casket type, urn selection, etc.). Additionally, the family advisor computer system is capable of both recognizing user-initiated events and accepting user-defined queries in order to take a defined action and/or return queried funeral related information from a remote system server's database. After viewing and selecting, the family advisor computer system filters the available products and services using the user's selected choices to provide the user with a list meeting the individual's specification. The products and services may thereafter be canceled, revised, or ordered.

When necessary the application, which is operating preferably on a funeral home's computer, communicates with the remote system server via a direct dial-up modem access or Internet access. The remote system server computer manages the control and availability of the existing inventory of funeral products and/or services available from preferred distributors and/or suppliers. Such communication is performed both to update the pricing and availability of products offered by the funeral home computer, and to place the order request with the proper distributor/supplier.

In particular, the application communicates with the remote system server, generally, at two instances. The first instance is at start-up when the remote system server is queried to determine which products and services are available and in stock. The distributor's inventory data is only accessible in the read only mode. The second instance is when the order is placed to reserve the products and services. Order information is limited to restricted directories on the remote system server in a “write only” mode. The gives the family advising computer system the ability to add data to the distributor's database without the ability of other system users to read any other customer's data.

In a second instance, the present invention is a method for arranging funeral services and products. A computer is used in the method for presenting, searching, selecting and maintaining funeral arrangement information contained in a database provided by a funeral products distributor. The computer comprises a memory device for storing information, a processor for computing application instructions, a keyboard for entering information, and a display terminal for displaying visual information related to funeral services and products. The computer further comprises a pointing device for selecting visual objects display on the display terminal, a speaker system for listening to audio information related to funeral services and products, and a communication device for connecting to a remote server database of a distributor of funeral products.

A software application running on the computer presents to a user a selectable options page for funeral arrangements, which provide various user selectable actions. The user can select these options or choices either by keyboard actions or by the pointing device. After selecting an option regarding the type of funeral arrangement generally interested in, the user is then guided through additional selectable option pages. The additional selectable option pages are design to provide information on the available funeral services and products and to enable the user to narrow down a selection of available services and products, thereby allowing the user to choose those services and products that meet the user's needs.

After making a decision of the services and products wanted, the computer with the necessary script command compiles from a database a summary list of desired funeral arrangements based on the user's selections. The summary list is then provided to the user and, if accepted, a products list based on the user's selections is forwarded to a distributor for processing and shipping.

In one embodiment, the present invention provides a computerized method for arranging a funeral. The method comprises presenting an electronic selection guide page which lists a plurality of selectable user actions for making funeral arrangements. The method further comprises displaying a first electronic response page in response to the selection of one of the plurality of user actions, wherein the first electronic response page displays information in at least one theme to stimulate ideas for personalizing the funeral.

In another embodiment, the present invention provides a computer-readable medium whose contents cause a computer to have a memory device store information related to funeral products and service, and to have a display terminal display information related to funeral services and products, and enable the computer to guide a user through the planning of a funeral.

In still other embodiment, the present invention provides a computer system for assisting a user in making funeral arrangements. The computer system comprises a display terminal, and a memory device storing information related to funeral products and service. The computer is running an application that displays the information related to funeral services and products on the display terminal and guides the user through the planning of a funeral.

These and other features and objects of the present invention will be apparent in light of the description of the invention embodied herein and the appended claims when taken in connection with the accompanying drawings.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 is a schematic block diagram of the system of the present invention;

FIG. 2a is a pictorial page view of a HTML home page illustrating an embodiment of the present invention;

FIG. 2b is a flowchart of the linked HTML pages and functions accessible for a home page in another embodiment of the present invention;

FIGS. 3a and 3b are pictorial page views of HTML form pages of the present invention for entering and retrieve information from a database, and for guiding a user through the funeral arrangement process;

FIGS. 4a, 4b, 4c, 4d, and 4e are pictorial page views of HTML information pages of the present invention for providing information in the form of text, pictures and video clips providing information about funeral services and products;

FIGS. 5a and 5b are pictorial page views of HTML graphical pages of the present invention for providing virtual theme selection rooms used to personalization.

FIGS. 6a and 6b are pictorial page views of HTML pages of the present invention providing summary information about the services and products;

FIG. 7 is a pictorial page view of a HTML page from which administration areas of the present invention are made accessible to a privilege user with a password;

FIG. 8 is pictorial page view of a HTML protected page of the present invention for a services maintenance module of the software application;

FIGS. 9a, 9b, 9c, and 9d are pictorial page views of HTML protected pages of the present invention for the products administration module of the software application;

FIGS. 10a, 10b, and 10c are pictorial page views of HTML protected pages of the present invention for a customer's maintenance module of the software application;

FIG. 11a and 11b are pictorial page views of HTML protected pages of the present invention for report generation module of the software application;

FIGS. 12a, 12b, 12c, 12d, 12e, 12e, 12f, 12g, 12h, and 12i are pictorial page views of HTML protected pages of the present invention for setup modules of the software application;

FIG. 13 is pictorial page view of a HTML protected page of the present invention for a cash advance module of the software application;

FIGS. 14a and 14b are pictorial page views of HTML protected pages of the present invention for an Order/Update module of the software application;

FIGS. 15-17 are flowcharts of the present invention of a first embodiment of a path that a user may take through a funeral arrangement process, and how HTML pages of the present invention link and relate to one another in this embodiment; and

FIGS. 18-20 are flowchart of the present invention of a second embodiment of a path that a user may take through a funeral arrangement process, and how HTML pages of the present invention link and relate to one another in this embodiment.

### DETAILED DESCRIPTION OF THE PREFERRED EMBODIMENTS

In the following detailed description of the preferred embodiments of the present invention, reference is made to the accompanying drawings, which form a part hereof and in which is shown by way of illustration specific embodiments in which the invention may be practiced. The preferred embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense as the scope of the present invention is defined by the appended claims.

The Internet, which can provide the communication medium of the present invention, is a worldwide “network of networks” that links millions of computers through tens of thousands of separate (but intercommunicating) networks. Via the Internet, users can access tremendous amounts of stored information and establish communication linkages to other Internet-based computers.

Much of the Internet is based on the client-server model of information exchange. The computer architecture, developed specifically to accommodate the “distributed computing” environment that characterizes the Internet and its component networks, contemplates a server (sometimes called the host)—typically a powerful computer or cluster of computers that behaves as a single computer—that services the requests of a large number of smaller computers, or clients, which connect to it. The client computers usually communicate with a single server at any one time, although they can communicate with one another via the server or can use the server to reach other servers. A server is typically a large mainframe or minicomputer cluster, while the clients may be simple personal computers. Servers providing Internet access to multiple subscriber clients are referred to as “gateways”; more generally, a gateway is a computer system that connects two computer networks.

In order to ensure proper routing of messages between the server and the intended client, the messages are first broken up into data packets, each of which receives a destination address according to a consistent protocol, and which are reassembled upon receipt by the target computer. Commonly accepted sets of transfer protocols for this purpose are the Internet Protocol, or IP, the transmission control protocol, or TCP, and the file transfer protocol, or FTP. The Internet Protocol dictates routing information of data, the transmission control protocol controls how data is actually broken up into IP packets for transmission and subsequent collection and reassembly, wherein the file transfer protocol uses separate simultaneous TCP connections for control and for data transfer. TCP/IP and FTP connections are quite commonly employed to move data across telephone lines by computer applications.

The Internet also supports a large variety of information-transfer protocols. One of these is the World Wide Web (hereafter, simply, the “web”), which to many is synonymous with the Internet. Each file of web-accessible information is identified by a uniform resource locator or “URL,” which specifies the location of the file in terms of a specific computer and a location on that computer. Any Internet “node”—that is, a computer with an IP address (e.g., a server permanently and continuously connected to the Internet, or a client that has connected to a server and received a temporary IP address)—can access the file of web-accessible information by invoking the proper communication protocol and specifying the URL.

Typically, a URL has the format <protocol>://<host>/<path>, where <protocol> indicates what protocol to use, such as, for example, HTTP refers to the Hypertext Transfer Protocol or FTP. The “host” is the server's Internet identifier (IP address) or “domain name” where a resource is located, and the “path” specifies the location of the file of web-accessible information within the server. The host is typically a “web site” (location) on the World Wide Web. The web site typically contains web accessible information, such as documents and files that are typically made available on one or more “web pages,” which are formatted, tree-structured repositories of information, such as text, images, sounds, and animation. The first web page that users see when they enter the web site is called a “home page.” It is to be appreciated that each home page and web pages is identified by a unique URL.

With the client machine connected as an Internet node, a computer application called a “web browser” utilizes the URLs—provided by either the user or a hyperlink—to locate, fetch, and display the specified web page or information. “Display” in this sense can range from simple pictorial and textual rendering to real-time playing of audio and/or video segments or alarms, mechanical indications, printing, or storage of data for subsequent display. The browser accomplishes the fetching routine by passing the URL to a protocol handler on the associated server, which then retrieves the information and sends it to the browser for display. Clients at various locations can view web pages by downloading replicas of the web pages, via browsers, from servers on which these web pages are stored.

Typically, the browser causes the retrieved information to be cached (usually on a hard disk) on the client machine. Additionally, the web browser is capable of executing hyperlink addresses and programs, and generally interpreting web-page information, such as data, transfer protocols, and computer instructions defining “potential functionality” that may be executed by the browser. It is to be appreciated that the web page itself contains information specifying the specific Internet transfer routine necessary to retrieve the document from the server on which it is resident.

Ordinarily, web pages reside on servers accessible via the Internet. However, the above-discussed mode of splitting functions between web pages and browsers can be instituted on internal networks as well. These networks, sometimes called “intranets,” support the TCP/IP communication protocol and typically serve the needs of a single business (or business department), which may be located at a single site (with individual clients connected by a simple local-area network) or multiple physically dispersed sites requiring a wide-area network but not access to the Internet. A number of the computers forming the intranet network can be utilized as servers for web pages, each with its own URL and offering access to network client computers via HTTP and FTP.

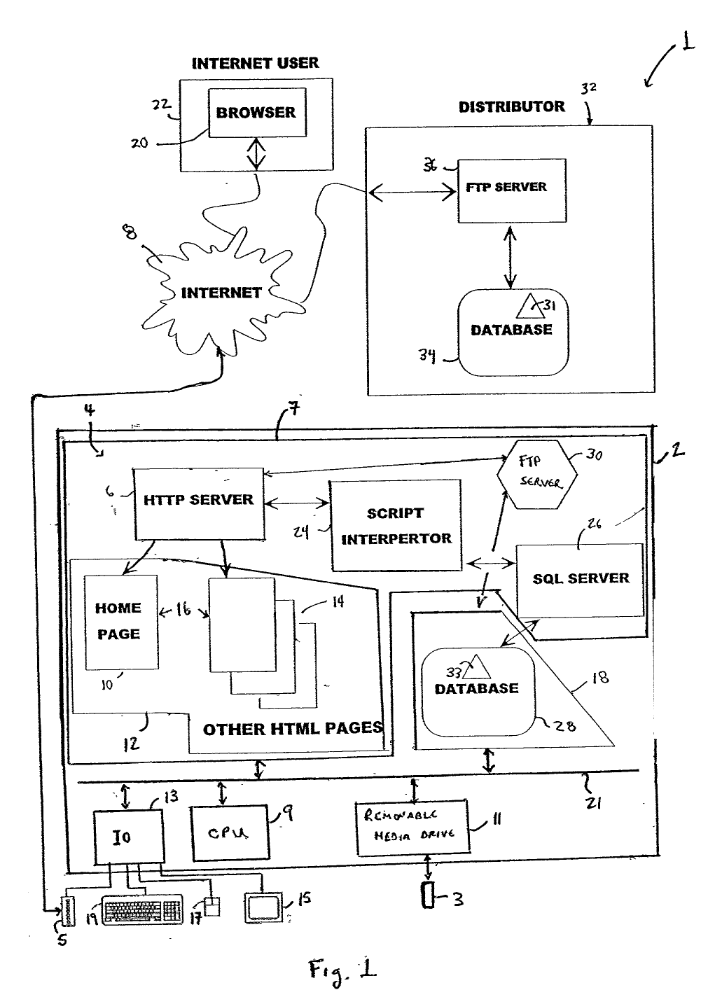

In this manner, FIG. 1 illustrates generally a family advising system, generally indicated by 1, that can perform the funeral arrangement methods of the present invention. The system 1 includes a computer 2 that can be programmed to perform these methods by loading software from a removable computer readable medium 3, such as a floppy disk or CD-ROM, or other suitable transfer medium. Alternatively, through a communication device 5, such as a modem or a network interface card, software may be loaded electronically over a network 8, such as through the Internet, or from an electronic bulletin board.

The family advising computer 2 includes hardware elements suitable for providing a general-purpose computing environment for a user, such as a suitable main memory 7, central processing unit 9, hard disk drive 18 or similar non-volatile data store, removable media drive 11, such as a floppy disk or CD-ROM, input/output circuitry 13, video display 15, mouse 17 or similar pointing device, and keyboard 19. The elements of computer 2 are interconnected in the conventional manner, in which each element in the computer communicates with one or more of the others via one or more busses 21.

Although computer 2 is illustrated as a stand-alone computer in which the software and methods described below are executed entirely within computer 2, other computing paradigms and architectures, such as the client-server paradigm in which some functions are executed on a client computer and others are executed on a server computer connected to the client computer via a network, would also be suitable.

Computer 2 is running in main memory 7 an Internet (World Wide Web) software application, generally indicated as 4, that performs the methods of the present invention. The application 4 includes a web browser 12, a HTTP server 6, a script interpreter 24, a FTP server 30, and a SQL server 26. A user can configure, initiate, and control the execution of this application 4 on computer 2 in the conventional manner. In addition to the application 4 comprising the above-listed elements and other programs described below that relate specifically to the present invention, computer 2 can include a conventional operating system (not shown) to facilitate the execution of such programs and other functions typically performed by operating systems.

Although the software elements of computer 2 which are principally relevant to the present invention are shown for purposes of illustration as existing or residing in main memory 7, persons skilled in the art to which the invention relates will understand that the application 4 is illustrated in this manner because software is typically executed from such main memory and fetched into the main memory on an as-needed basis from other sources such as the hard disk drive 18 or the network 8. As such, persons will appreciate these software elements may or may not actually exist simultaneously or in their entirety in main memory 7.

The HTTP server 6 establishes and manages the connection of the application 4 to the network 8 for both local and remote users. To provide the input/output interface into the family advising computer 2, the HTTP server 6 parses a home page 10 and other web pages 14, thereby forming a web site 16, to a local user on the local browser 12. The HTTP server 6 may also, if desired, be use to parse through the network 8 the pages 10 and 14 of the web site 16 to a remote user using a remote browser 20 on a remote computer 22 connected to the network 8. The remote computer 22 is conventional therefore, no further discussion is provided. It is to be appreciated that the pages of the web site 16 may be written in, for example, HTML or other languages (e.g., VRML, XML, SGML, etc.) identified on the server 6.

Preferably, the web pages 10 and 14 of the web site 16 contain multiple lines of code or tags (not shown) written in Hyper-Text Markup Language (HTML). HTML is a simple, universal mark-up language that breaks the document into syntactic portions (such as headings, paragraphs, lists, etc.) that specify layout and contents. Although HTML produces static web pages, other languages overcome the static page appearance dictated by HTML, such as for example, Java, Active X, and Dynamic HTML.

The Java language is a well-known, machine-independent, interpreted computer language that facilitates dynamic display of information. Java-encoded “applets” are stand-alone programs embedded within web pages that can interact with the user locally, display moving animations and perform other functions on “Java-capable” browsers—that is, browsers which include a Java interpreter. The applet is transferred to the browser along with other web-page information and is executed by the Java interpreter; the data acted upon by the applet can be located on the same or a different web page, or a different server entirely, since applets can themselves cause the browser to retrieve information via hypertext links.

ActiveX and Dynamic HTML controls represent an alternative to Java, although they typically require compatible browsers and computers. These programs can be written in many computer languages (including Java) and usually compile to machine code, in which case they operate only in conjunction with browsers running machines with appropriate processor architectures. Some languages, however, will compile to machine-independent byte codes, which can run on a variety of processor architectures.

Accordingly, HTML, Java, ActiveX and Dynamic HTML controls allow Internet publishers to create complex multimedia web pages of text, graphics, tables, buttons, images, sounds and videos each identified by a HTML tag. The HTML tags, which are embedded on the web pages and hidden from users, define the above-mentioned functions.

In particular, one type of HTML tag is called a hyperlink or hot spot, which connects web pages 10 and 14 to each other and to other web pages accessible over the network 8. The hyperlink typically appears unobtrusively as an underlined portion of text in a document; but when the viewer of the document clicks on the underlined text, the hyperlink is executed and the linked information is retrieved. Hyperlinks thus allows a user to navigate through the web site 16. Hyperlinks may also be designed by images provide on the web pages.

The web site 16 of application 4 is preferable stored on a local drive 18 to which the HTTP server 6 has access. However, if desired, the documents and multimedia files linked from the web pages of the site 16 may be accessible over the network 8, and as such need not be located on the local drive, or on the same server 6.

As explained previously above, to view the home page 10, the local browser 12 or the remote browser 20 requests the HTTP server 6 to parse the home page 10. After receiving the home page 10, the embedded HTML tags (not shown) tell the browser 12 or 20 what to do, what is on the page, and how the page should be displayed. Once the user has accessed the home page 10, the user is then guided through the web site 16 of the application 4 to both help arrange a funeral and provide, when requested, detailed information about the funeral care process.

In the present invention, some of the additional HTML pages 14 allow the entering and processing of information by the computer 2. These types of HTML pages, herein after referred to as form pages, contain input fields that enable information to be sent to the HTTP server 6 for further action. A form page when displayed by a browser 12 or 20 generally displays an assortment of text entry boxes, drop-down boxes, radio buttons, and check boxes, by which the user enters information into hidden input tags.

After entering information into the provided input boxes on the form page(s), the user clicking on a hot spot or button instructs the browser 12 or 18 to post the information contained in the hidden input tags back to the HTML server 6. The HTTP server 6 analyses the incoming data and looks for identifier information that tells it what program will deal with the data processing request. The HTTP server 6 accomplishes its data processing task by passing a hidden script file (not shown) provided on the HTML page to a script interpreter 24. The script interpreter 24 extracts the information from the input tags and passes that information to the proper program as instructed by the script file such as, for example, to the SQL server 26.

It is to be appreciated that the script file is nothing more than an instruction or a set of instructions telling the script interpreter 24 to do something. For example, a script file may instruct the script interpreter 24 to have the SQL server 26 to write the passed information to a database 28 stored on the local drive 18. Additionally, the script file could instruct the script interpreter 24 to request information from the database 28, in which case the SQL server 26 extracts the requested information and then passes the queried information back to the HTTP server 6 for presentment to the browser 12 or 20.

The family advising system 1 also comprises a distributors system, generally indicated as 32. A FTP server 30 is further shown by FIG. 1, which allows the family advisor application 4 to upload and download data files 31 and 33 between the distributor's system by 32. The distributor's system 32 is conventional, and generally comprises a remote database 34 and a remote FTP server 36 for linking with the FTP server 30 of the application 4 to establish an FTP session. Establishing a FTP session requires logging on to the distributor's system 32 in the same way that a user logs into a local network or ISP, and may be established through the browser 12 as is known.

Once the FTP session is established, data files 31 and 33 are preferably transferred between the remote FTP server 36 and the FTP server 30 of the family advising computer 2 via the network 8. However, it is to be appreciated that a direct-dial up using the communication device 5, such as being a modem, could also be used to transfer files if desired, or establishing a virtual private network or extranet if also desired. In still another embodiment, the server 6 may support either SHTTP or SSL connections in order to connect securely to the distributor's server 36. A discussion on the types of web pages 10 and 14 of the web site 16 presented and used by the computer 2 to setup and implement the funeral arrangement processes now follows.

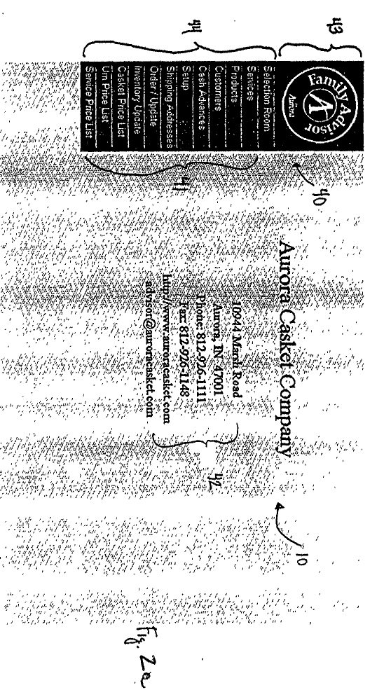

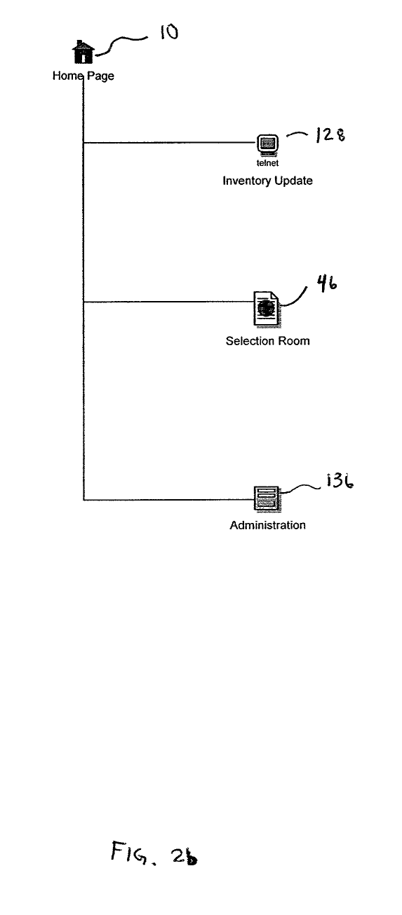

FIG. 2 depicts the home page 10 in a first embodiment of the present invention, which provides a navigation toolbar 40 and contact information 42 of a funeral provider. The navigation toolbar 40 includes an application logo 43 and user-selectable hot spots or hot buttons 44. Hot buttons 44 represent HTML hyperlinks that each points to a particular HTML page, thereby allowing a user to navigate to and from different pages available on the site 16. As known, the HTML hyperlinks may point to HTML pages in other web sites connected to the network 8, as well as other items such as documents, videos, images, and the like. Additionally, it is to be appreciated that the navigation bar 40 in other embodiments may be customized to point to any number of other HTML pages and/or revised to present fewer HTML hyperlinks to minimize the user's navigation options from the home page 10.

For example, the flow chart as diagrammed by FIG. 2b, shows that in another embodiment the linkable pages from the home page 10 include a telnet inventory update function 128 (explained in a later section), an administrative areas access page 136 from which a privilege user may access all the administrative functions 41, and a selection room page 46 from which to start the funeral arrangement process. Accordingly, the system provides a virtual selection room and process by which to conduct business electronically with a customer such that users do not need to enter an actual selection room at the funeral home to see funeral products, i.e., the caskets and ums, and/or arrange funeral services. The computer 2 thus provides users with the convenience of viewing and selecting from a computer display screen all of the products and services available from the centralized supplier, as well as additional services and products from other vendors, if desired.

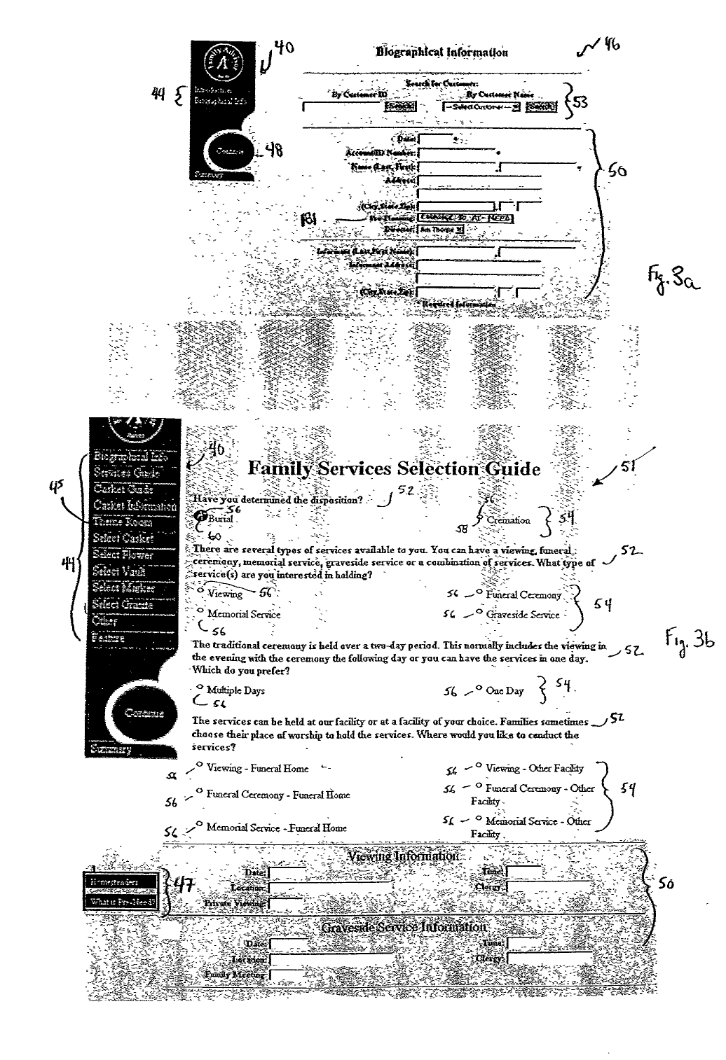

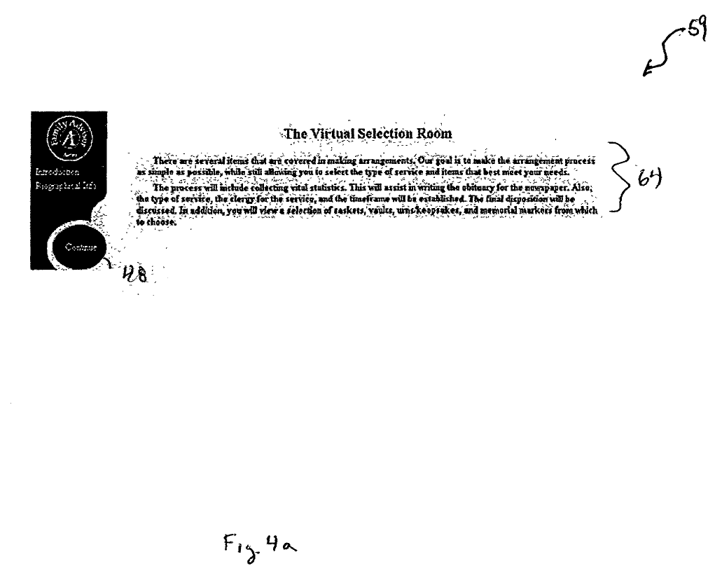

As will be explained in a later section, from the first virtual selection room page 46 users are then lead through the funeral arrangement process in which various forms of information, such as text, graphics, images, and video clips may be viewed to educate users about the manufacturing process and the different types of services and products that are available. On some of the HTML pages, users may also view close-ups of the products, such as for example, casket interior panels, hardware and corner details. This ensures that users are satisfied with the value of the products and services that the funeral home has to offer through the computer 2. Additionally, this ensures that users leave the funeral arrangement process feeling confident with the decisions made. Decisions are made by users on HTML pages such as, for example, illustrated by FIGS. 3-6, and which a discussion thereof now follows.

FIGS. 3a and 3b illustrate form pages used by a user to input information into the computer 2 for action. As depicted, the user-selectable hot buttons 44 on navigation toolbar 40 differ between FIGS. 2 and 3a. It is to be appreciated that hot buttons 44 of navigation toolbar 40 may dynamically change with each newly display HTML page to indicate to the user which HTML pages are navigable to from the currently shown HTML page. For example, from the form page 46 illustrated by FIG. 3a, the user may returns to the home page 38 or continue to the next linked page, via a hyperlink represented by a “Continue” button 48.

On the illustrated form page 46, provided are input boxes 50 and search fields 53 used to input and/or search for biographical information in the database 28 that contains a plurality of customer records. Each customer record is indexed in the database 28 by a unique customer identification number, the date, an account ID number, the customer's full name, address, the type of planning, either pre-need or the defaulted, at need, and the director providing counseling to the user. Additionally, provided is information regarding who should be contacted upon the death of the user. Since the data structure of the database 28 is conventional, no further discussion is provided.

Continuing with the discussions on the types of HTML pages presented to users during the funeral arrangement process, FIG. 3b depicts a form page 51 used to guide users through the funeral process with questions and prompting for inputting known data. As illustrated, a series of questions 52 each with set choices 54 are presented to the user for answering. It is to be appreciated that the questions presented on such pages may be customized as will be explained in a later section.

Each of the set choices 54 has an associated radio button 56 that allows the user to indicate a preference for funeral services and products. As known, the radio button 56 has two states either unflagged 58 or flagged 60, which sets a state condition within the computer 2. Accordingly, the radio buttons 56 are used to input information into the computer 2 about a particular user's choices and preferences.

In addition, the selection of a particular radio button and/or check box can be used by the computer 2 to customize the information that is presented to the user. Furthermore, certain radio buttons 56 and/or check boxes may be used to enable a script file (applet) that performs a certain task. Such a script file, for example, may run immediately, after the user clicks the continue button 48, or at a later defined time and perform a task(s) such as running a video, popping-up an information window, changing the format/language of the information presented to the user, changing the funeral arrangement process path, and/or the like.

On certain form pages 51, the user may be provided with input boxes 50 for collecting information. As is illustrated, for example, by FIG. 3b, the provided input boxes 50 are used by the user to enter known dates and locations of a funeral viewing and/or a graveside service, the attending clergy, and whether or not the specific event is open to the public. Furthermore, on certain form pages the navigation bar may include additional hot buttons 44, which permit users to access other HTML pages providing specific information regarding certain service(s) and/or product(s) for which a decision by the user is to be made. For example, a theme room button 45, if provided, presents to the user for viewing an example of a virtual selection room which is arranged in various themes. Moreover, other hot buttons 47 may be provided to link to still further information pages, if available in the computer 2, such as for example, explaining and selecting a pre-need service.

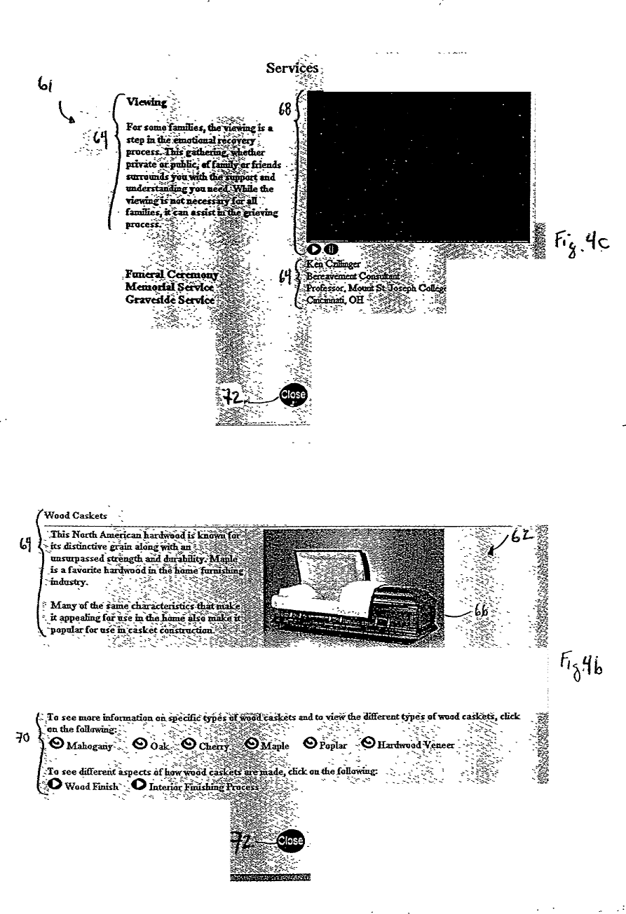

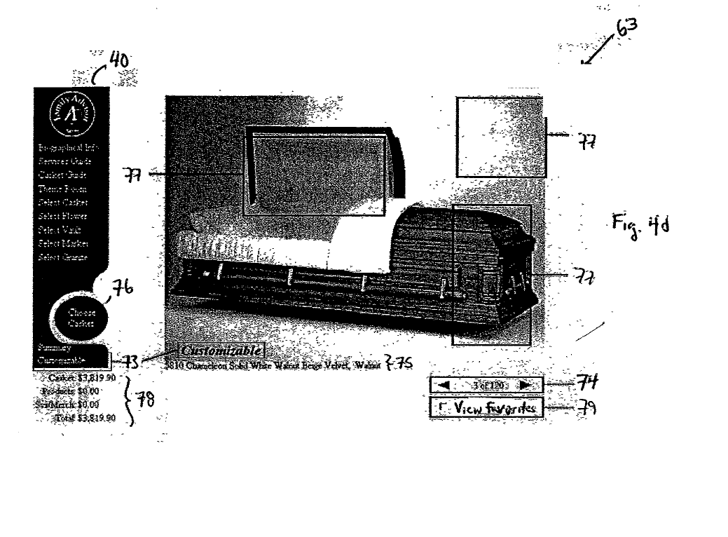

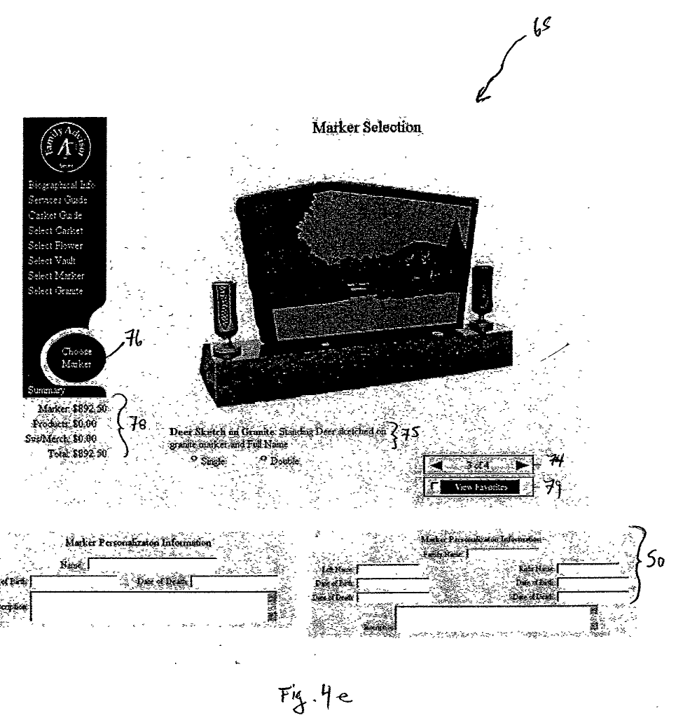

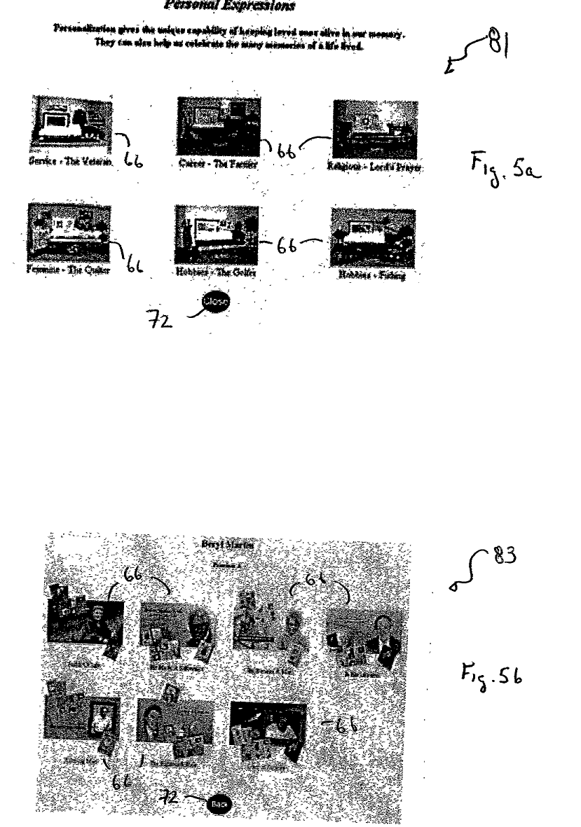

FIGS. 4a, 4b, 4c, 4d, and 4e illustrate examples of HTML information pages 59, 61, 62, 63, and 65 respectively, of the present invention from which the users view and/or select services and/or products offered by the computer 2 in an organized manner. As will be explained in a later section, the order in which these services and/or product is presented to the user may be customized. The HTML information pages 59, 61, 62, 63 and 65 may contain text 64 (FIG. 4a), graphics/pictures 66 (FIGS. 4b), video clips 68 (FIG. 4c), item choose or selection button 76 on the navigation toolbar 40 for adding the service and/or product to a purchasing list (FIG. 4d), input boxes 50 (FIG. 4e) or any combination thereof.

To navigate to other HTML pages 14 within the site 16 of the application 4, these pages may be provided with a continue button 48 (FIG. 4a), additional information selection buttons 70 (FIG. 4b), a close button 72 (FIG. 4b), and/or forward and back buttons 74 (FIG. 4c). Clicking on the continue button 48 takes the user to the next page in the funeral arrangement process, where as clicking on the close button 72 brings the user back to the previously viewed page. The forward and back buttons 74 are for viewing a series of pictures 66 from the HTML information page 62. The product name and/or description are provided on the page in a display box 75 (FIGS. 4d and 4e).

Furthermore, as depicted by FIG. 4d also includable on the information pages is an information box 78. The information box 78 is designed to display a running price summary for the products and services selected as order during the funeral arrangement process. The running price summary allows the user to select preferences, see their immediate monetary effect thereby allowing the user to adjust those choices accordingly. Moreover, for the products that are customizable, such as caskets, urns, and markers, that have interchangeable hardware, such as for example, insert panels, scroll work, selectable interior materials, and engraving, the computer 2 will present to the user a customizable indicator 73 (FIG. 4d) and/or input boxes 50 (FIG. 4e) by which to receive personalization information, such as for engraving.

For those certain customizable products, the computer 2 will highlight those interchangeable parts via outline boxes 77. Clicking on any one of the displayed outline boxes 77 will bring the user to other information pages where the user may view close-ups of areas detailed in the outlined boxes 77, and/or select from an array of customizable hardware pieces, such as for example, caskets with interchangeable corners, tribute panels, and keepsakes. Moreover, a View favorite button 79 may be provided on such information pages to help the user to narrow down the selection of items to those product which have been designated as favorites by a privilege user as will be explained in a later section.

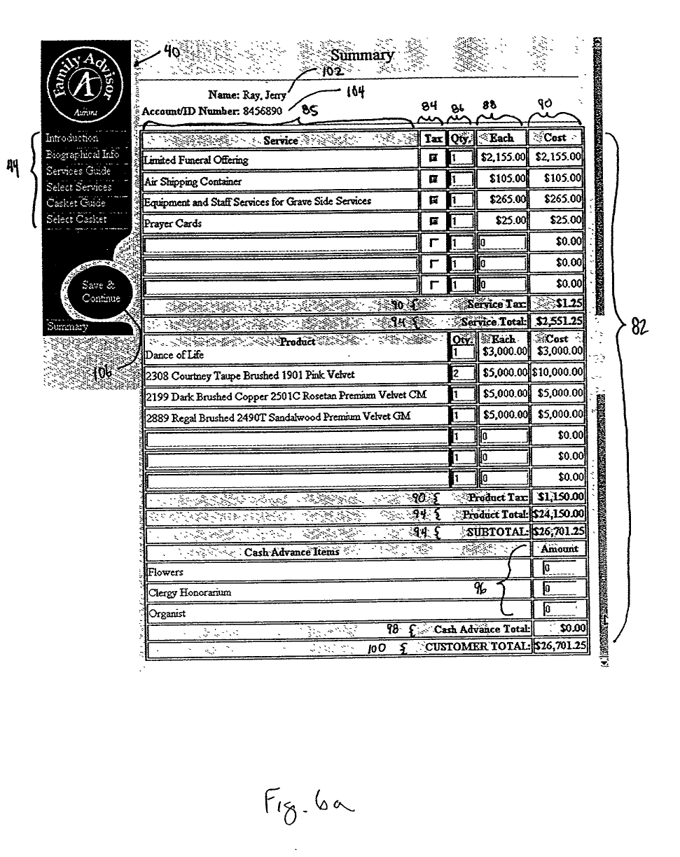

To further help users narrow down their selection process, the computer 2 also includes HTML personalization pages 81 and 83 as illustrated, for example, by FIGS. 5a and 5b, respectively. The personalization pages 81 and 83 permit the user to choice from a series of personalization choices for memorializing a life in unique and comforting ways. Since more and more families are looking for products and services to help them memorialize their loved ones, the personalization pages provide a funeral director the opportunity to display personalized products and viewing themes without making expensive modifications to their selection room.

As illustrated by FIG. 5a, the “Personal Expression” personalization page 81 presents to the user a variety of virtual selection room images 66, each arranged in a different tribute theme, such as religion, military veterans, family, ethnicity, special hobbies, and the like. With such virtual selection room images, the user can more conveniently select one of the themed package choices and/or generate more ideas for funeral personalization. Additionally, as illustrated by FIG. 5b, a series of personalization product images 66 are presented such that the user may also select and order online an assortment of specially designed printed products, such as for example, Beryl Martin™ products. It is to be appreciated that selecting any one of the displayed images 66 links the user to other information pages providing the user with additional information, questions, and/or input boxes by which to further personalize and/or order the designated product.

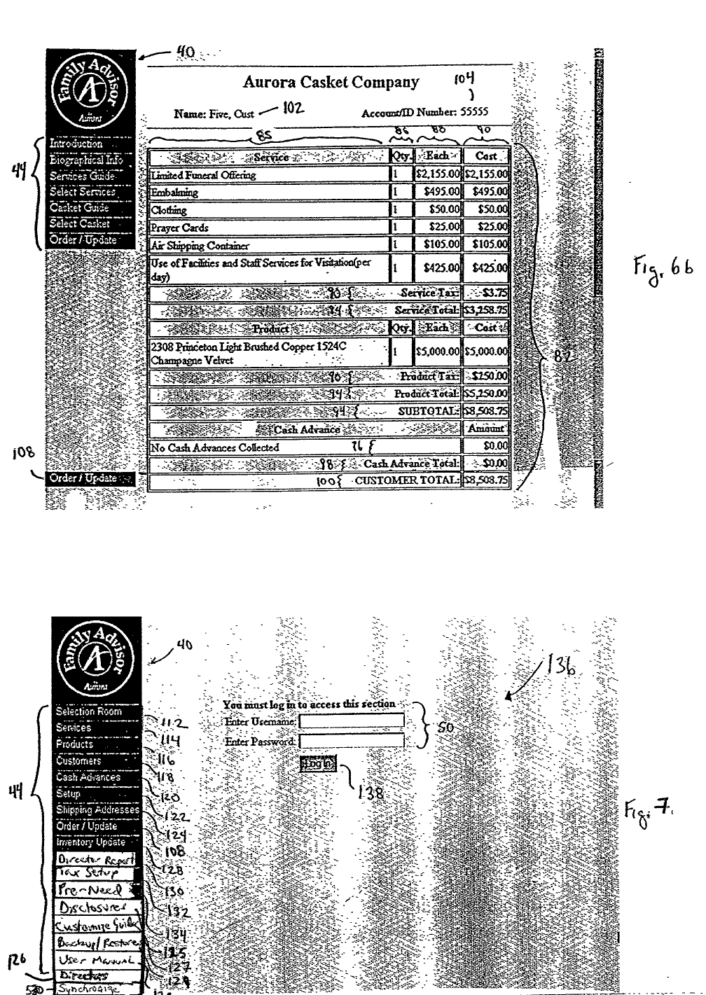

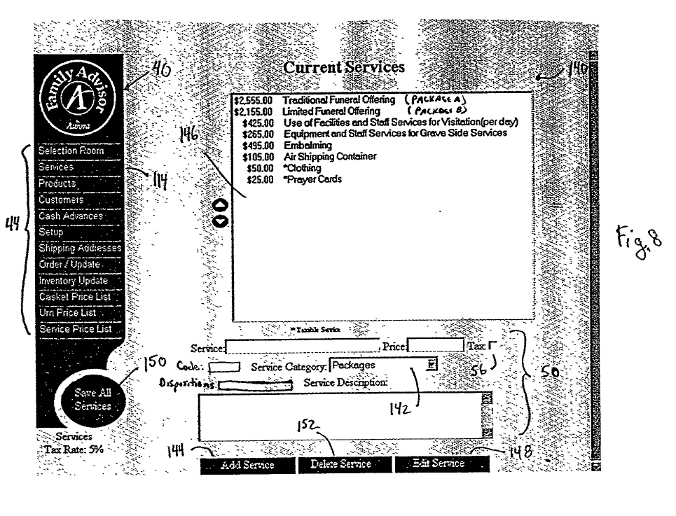

FIGS. 6a and 6b depict HTML summary pages 80 and 81 of the present invention that provide summary information, in editable categories, generally indicated by 82, on user selected services and products. The editable categories 82 listed include a name 83 for the service or product selected, tax indicator 84, quantity 86, individual price 88, cost 90, tax 92, sub-total price 94, cash advance amount 96, cash advance total 98, and customer total 100. Additionally, shown on the summary pages 80 are a user name 102 and an account/ID number 104. As illustrated by FIG. 6a, the navigation toolbar 40 provides a save & continue button 106 for saving the selection to the file 33 on the local drive 18 and for moving onto the next page. The summary page illustrated by FIG. 6b includes an order/update button 108 for forwarding, via an FTP session, the product-ordering information from the file 33 to the distributor's system 32 for further processing. A discussion on the administrative modules of the family advising application 4 now follows.

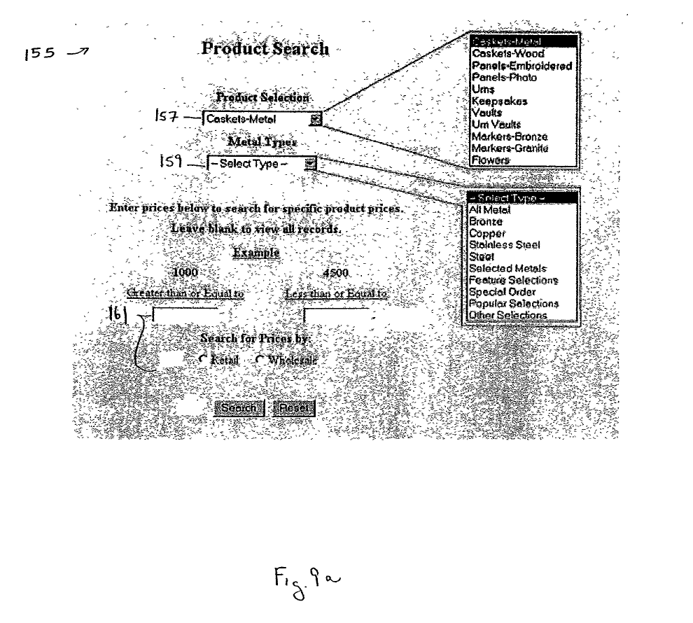

Referring to FIG. 7, illustrated is a HTML page from which administration areas of the application 4 are made accessible to a privilege user with a password. The administrative area access page is generally indicated by 136. The protected areas include services administration, product administration, the customer database, a cash advance area, a system setup area, a shipping addresses area, tax setup, pre-need information setup, disclosure information setup, customizable guide setup, reports/price lists, backup/restore functions, order/update, synchronize, mark-up, registration, and an electronic user manual. Any user selecting one of the above-mentioned protected pages of the application 4 when presented on the navigation bar 40 will be requested to enter a password on the administrative areas access page 136. The privilege user after entering both an authorized name and a correct password into the provided input boxes 50 clicks on a login button 138 to gain entry to the above-mentioned protected pages.

In one embodiment, the hot buttons 44 provided on the navigation bar 40 of the administrative areas access page 136 include a “Selection Room” button 112, and a “Services” button 114. It is to be appreciated that clicking on the “Selection Room” button 112 starts the funeral arrangement process (password not required), in which the user is presented with an information page, such as illustrated by FIG. 4a, which gives the user a brief explanation about the funeral arrangement process. Clicking on the “Services” button 114 takes the privilege user to a “Current Services” page (FIG. 8) for service setup and administration.

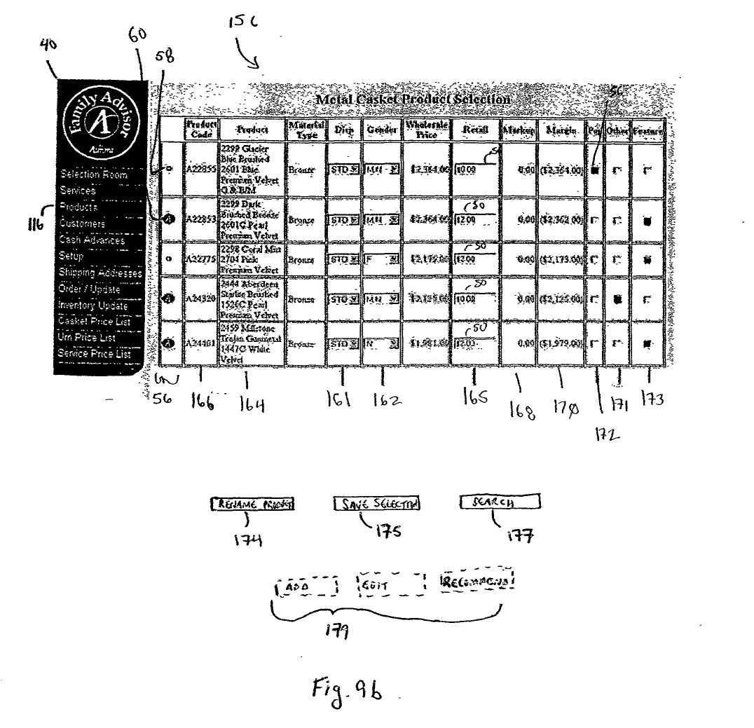

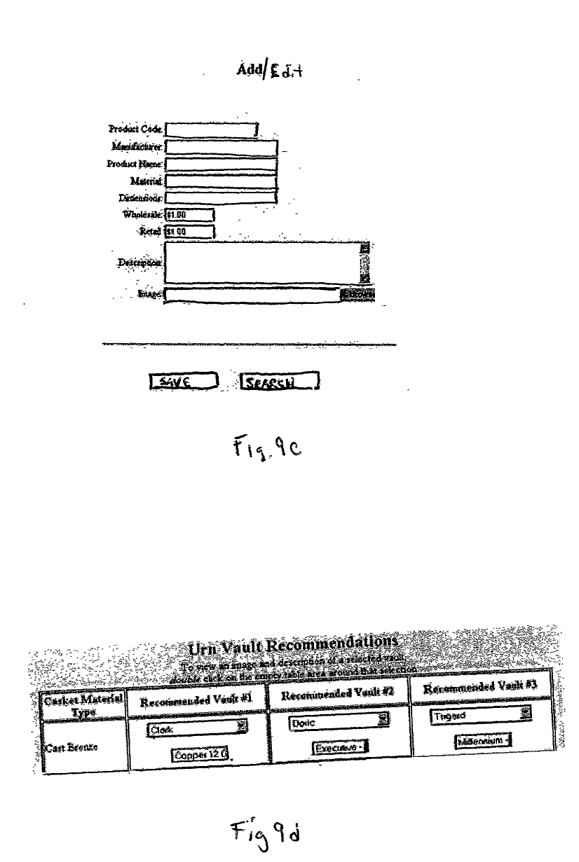

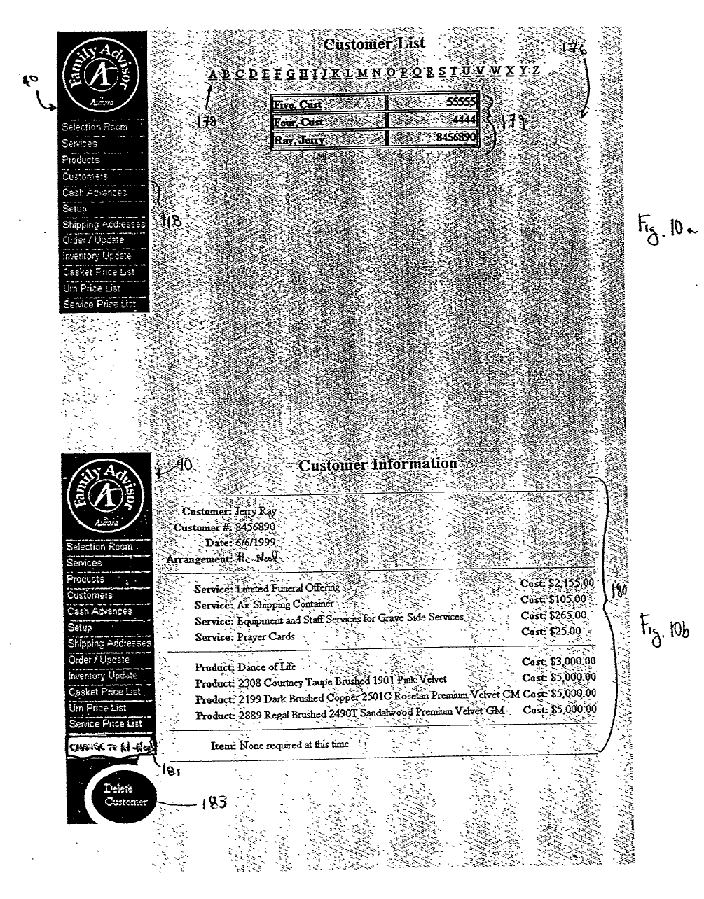

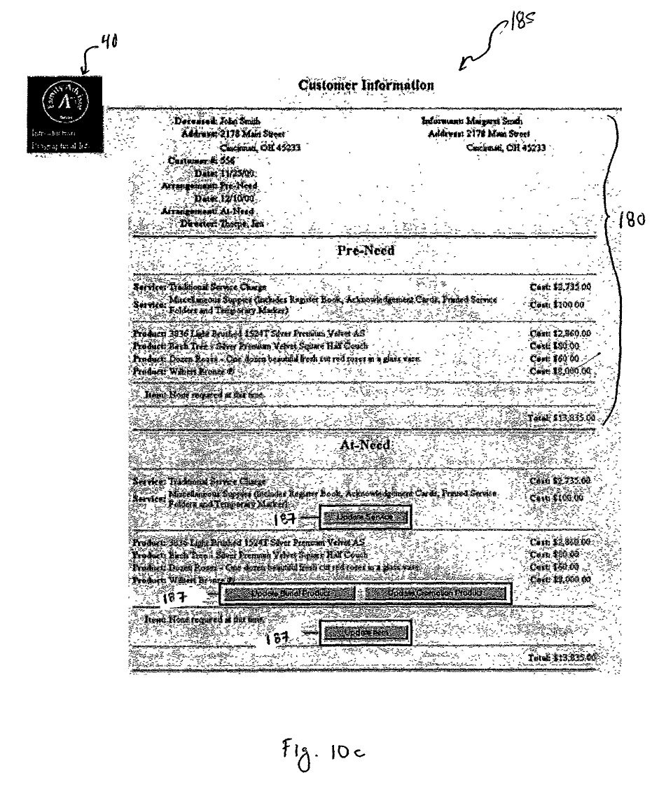

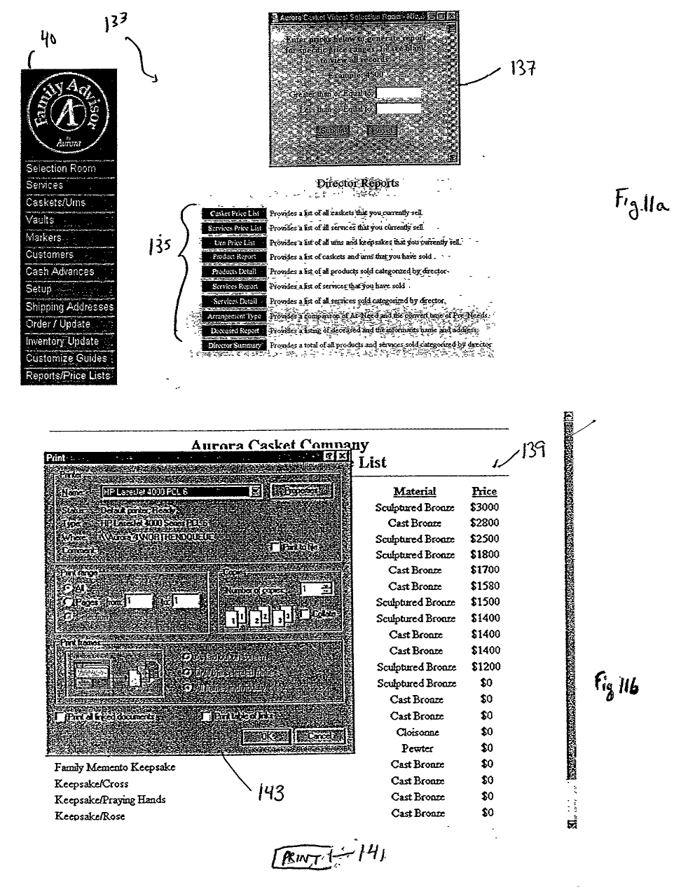

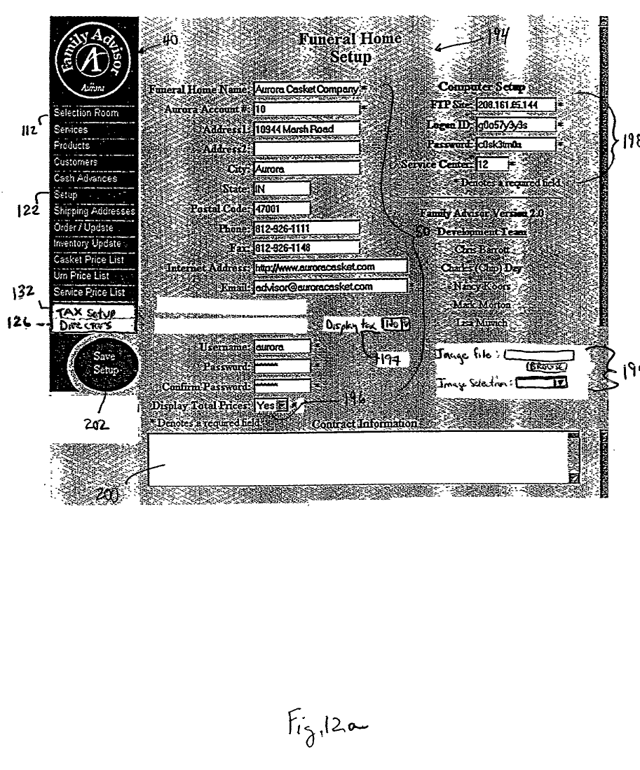

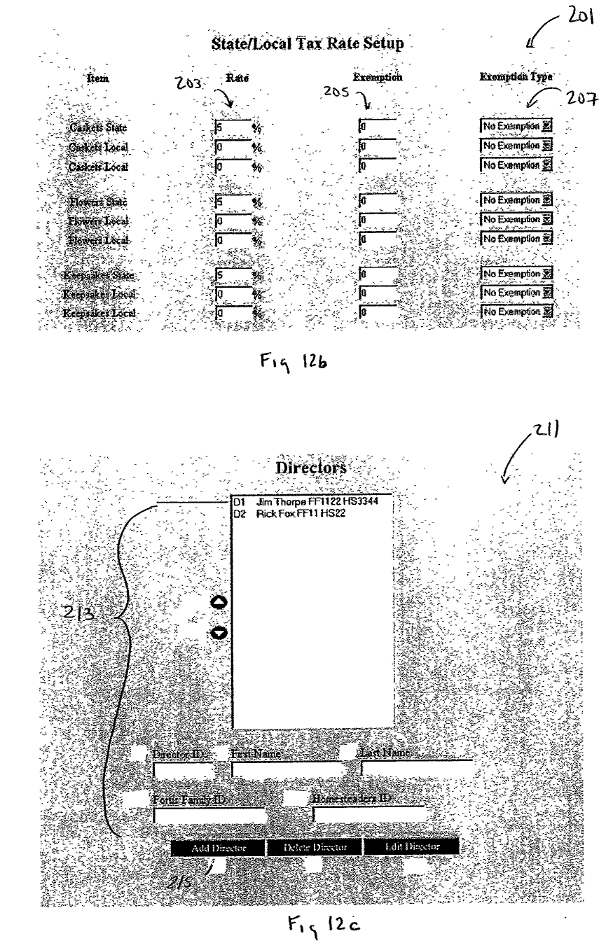

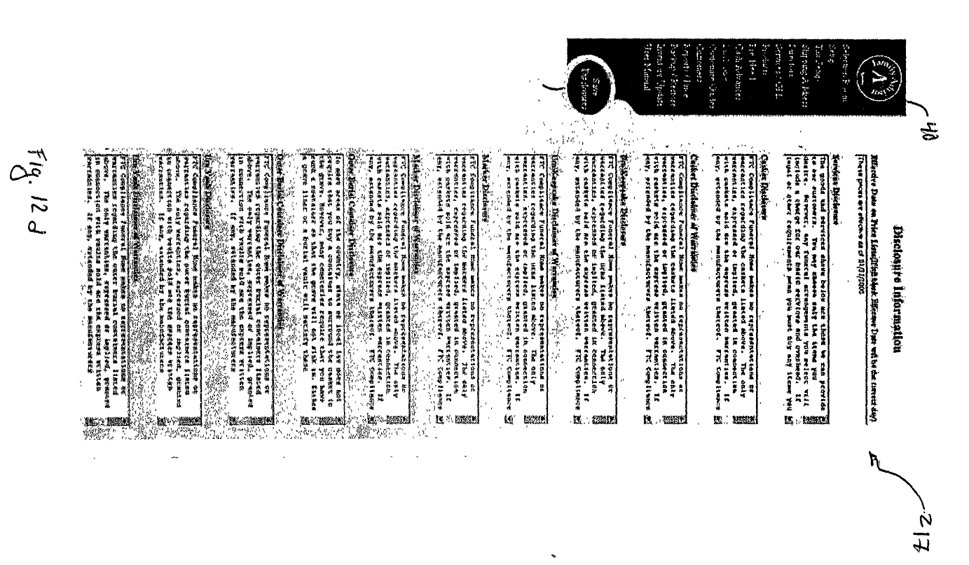

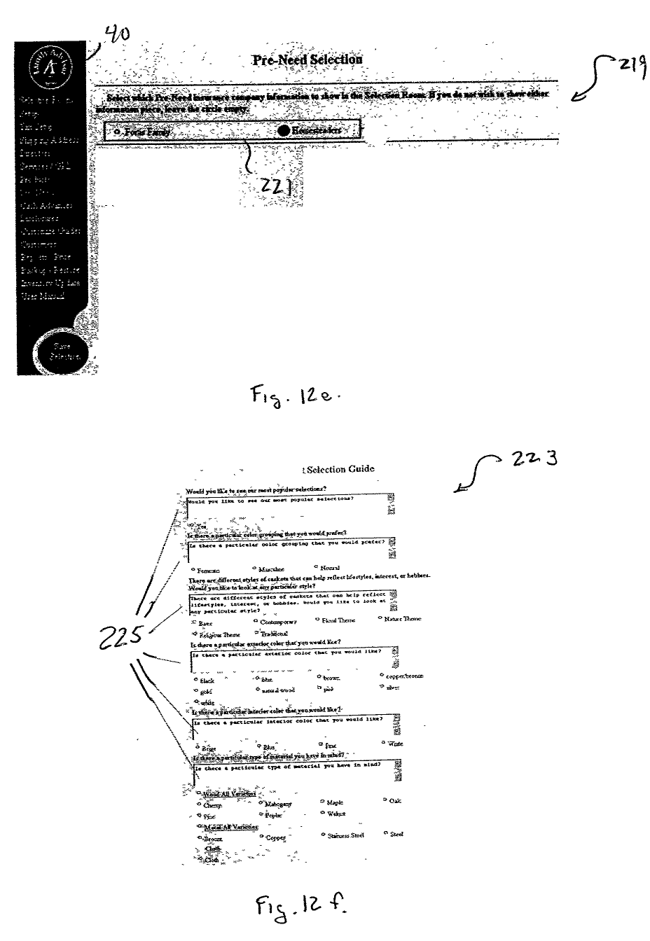

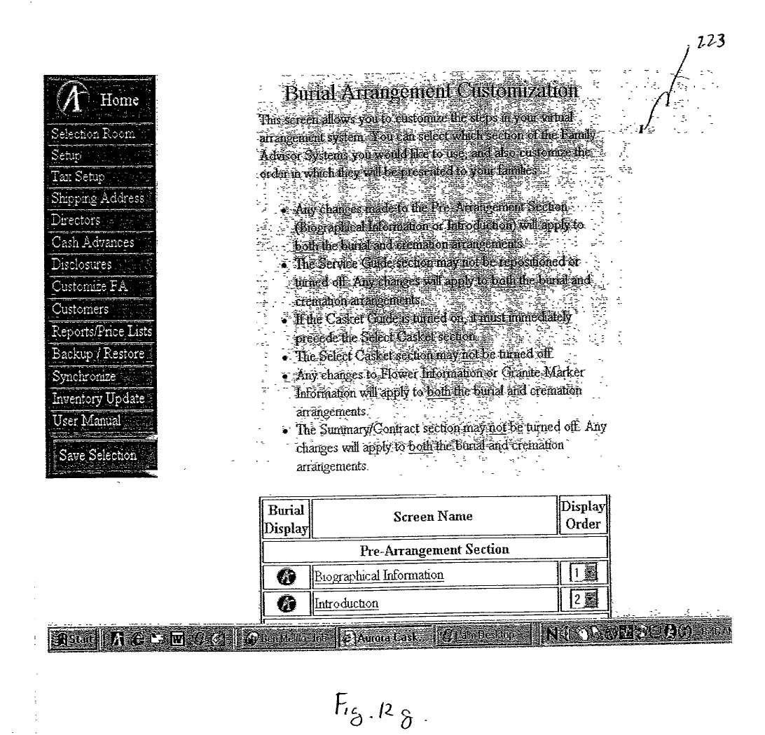

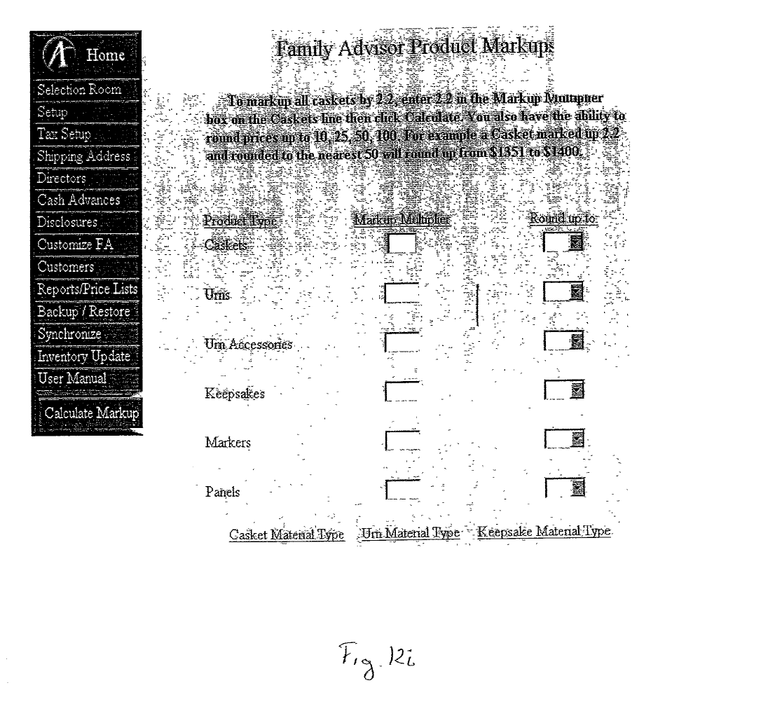

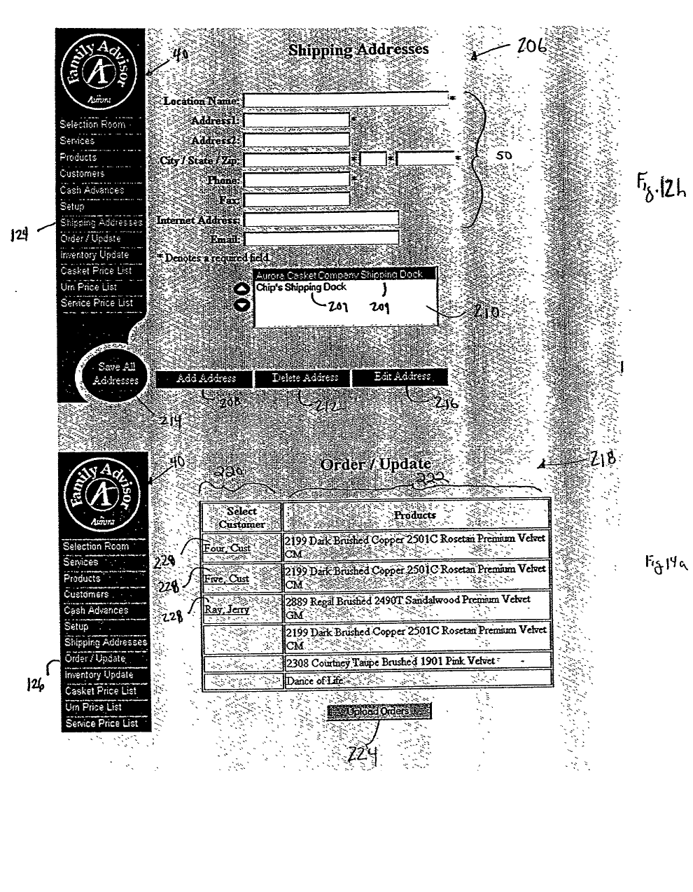

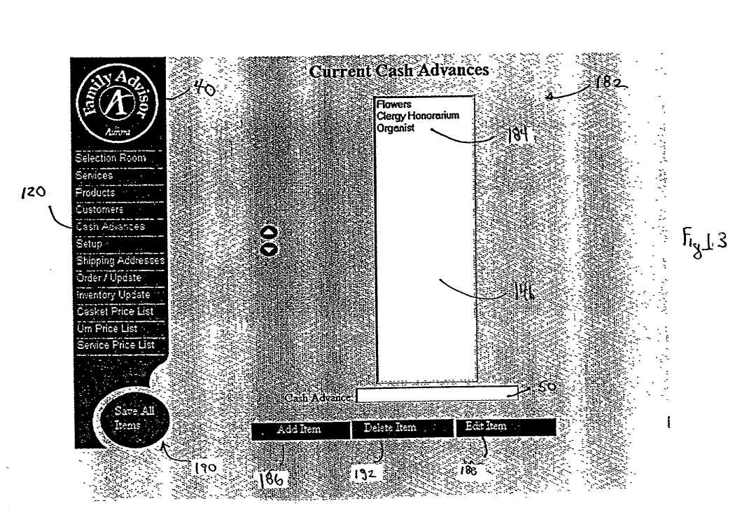

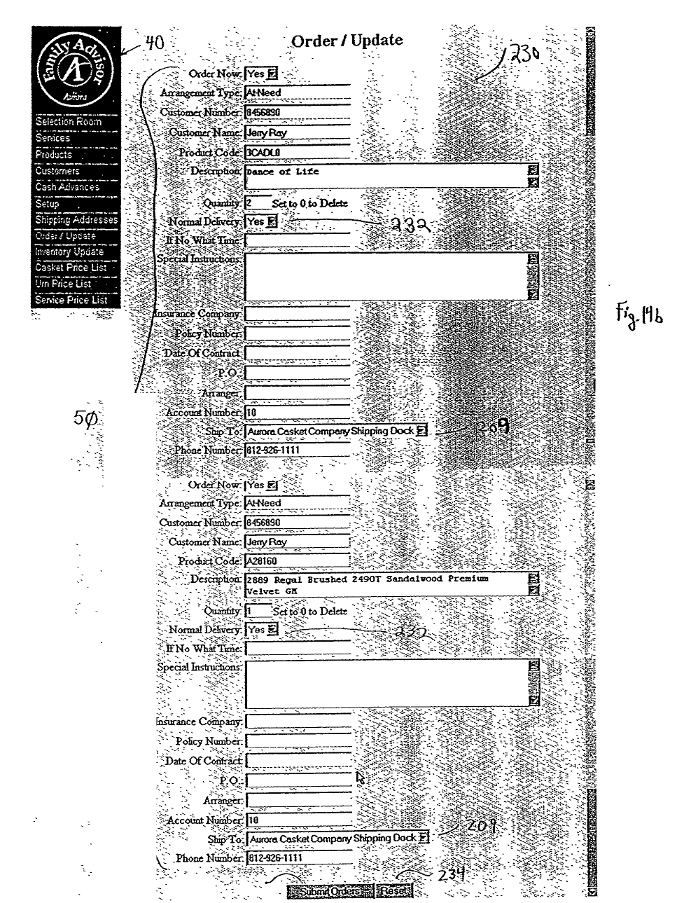

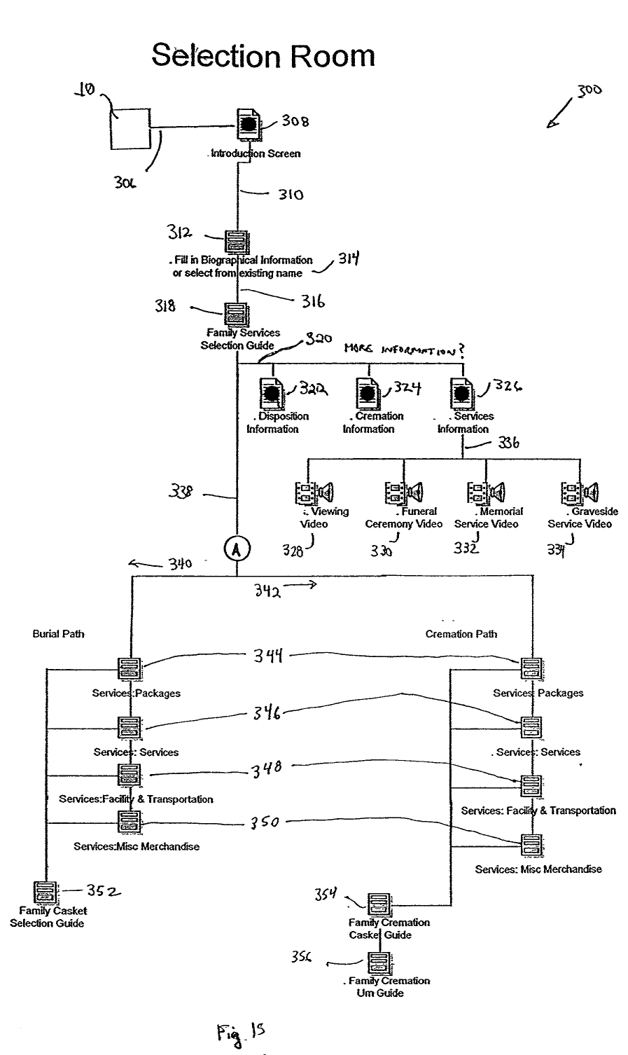

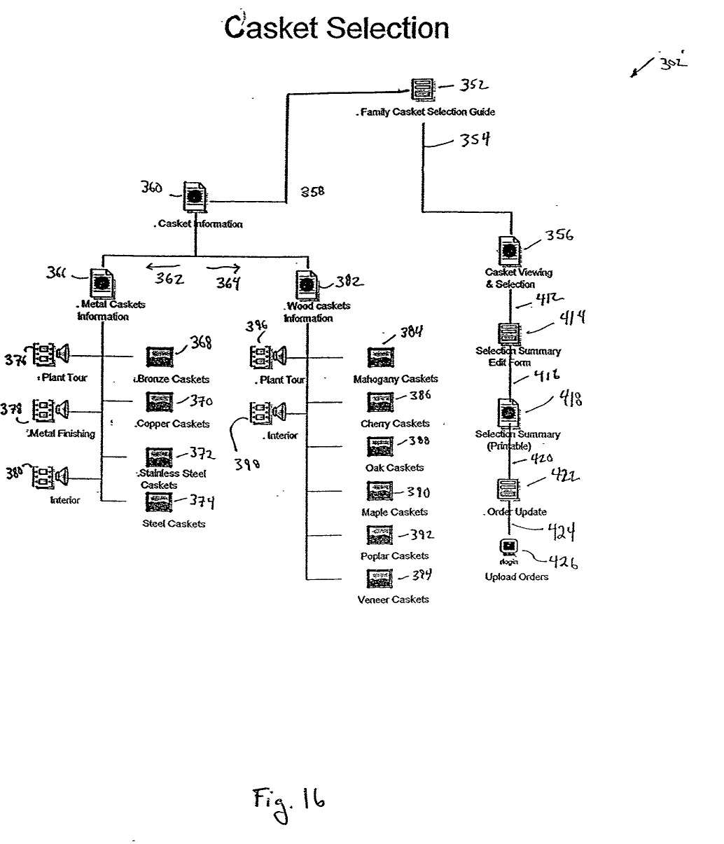

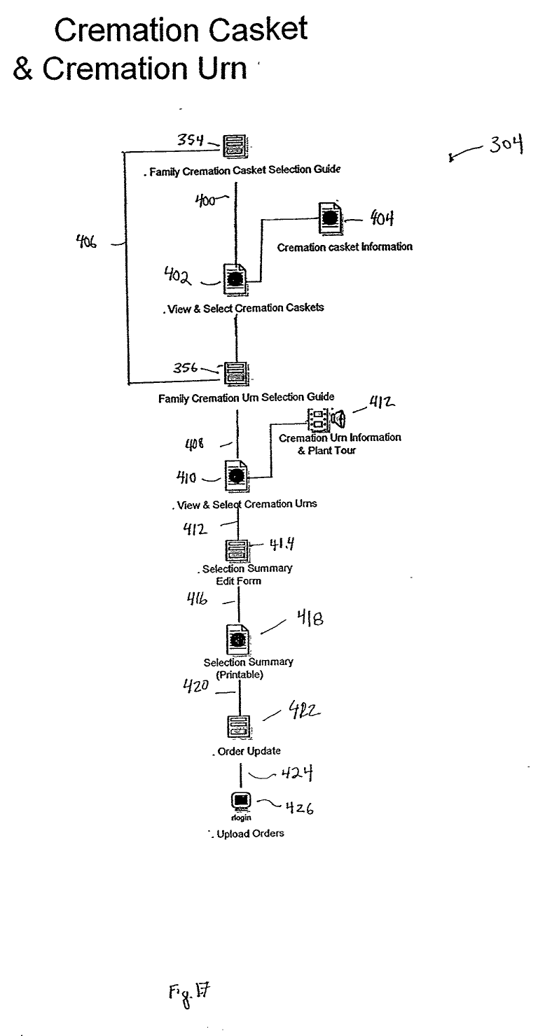

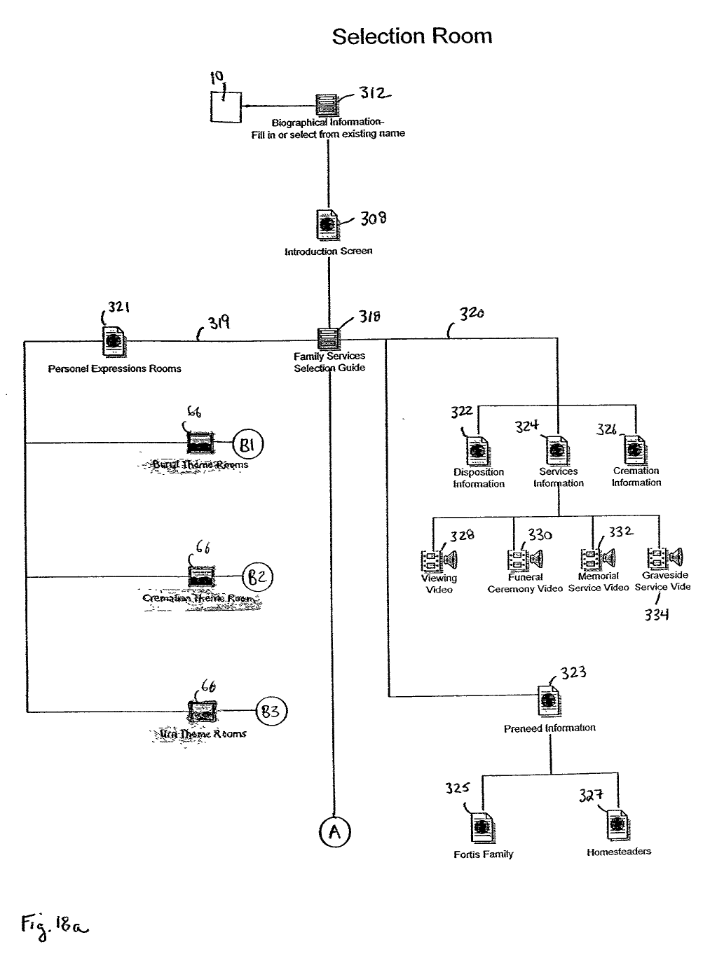

A “Products” button 116 is also provided on the navigation bar 40 to open a “Products” page (FIG. 9a) for products setup and administration. Also included on the navigation bar 40 are a “Customers” button 118 to open a customer administration page (FIG. 10a), a “Cash Advances” button 120 to open a cash advance setup page (FIG. 13), and a “Setup” button 122 to open a system setup page (FIG. 12a). A “Shipping Addresses” button 124 is also provided to open a shipping addresses setup page (FIG. 12h), as well as the “Order/Update” button 108 to open the order/update administration page (FIG. 14a), and an “Inventory Update” button 128 to perform an inventory update function, as will be explained in a later section. Other buttons include a “Director Reports” button 130 to run and print out a number of selectable reports (FIG. 11 a), and a “Tax set-up” button 132 to input local, regional, and state tax rates and exemptions (FIG. 12b).

Still other hot buttons 44 include a “Disclosure” button 125 is also provided which opens a disclosure page 217 (FIG. 12d) from which the privilege use may fill out various disclosure and disclaimer of warranties information. A “Directors” button 126 opens a directors page (FIG. 12c) on which the user sets up director information regarding each director using the computer 2. A “Pre-need” button 134, which open a pre-need setup page 219 (FIG. 12e) from which the privilege user selects what pre-need Insurance information from a particular pre-need company should be displayed. Other buttons further include “Customized Guides” and “Back-up Restore” buttons, 127 and 129, respectively, as well as a “User Manual” button 131. The “Customize Guides” button 127 opens a “Customized Guides” form page 223 (FIG. 12f) that permits the privilege user to customize the format and questions 225 presented in the selection guides for caskets, cremation caskets, and urns as will be explained in a later section. The “Backup/Restore” button 129 allows the user to backup or restore the database 28 to a previously saved file, and a “Synchronize” button 530 allows the privilege user to download data from portable computers, such as laptops, to the system 1. The mark-up button 532 takes the user to a markup page (FIG. 12i) from which the user may markup wholesale prices by a set amount for all products, such as caskets, urns, urn accessories, keepsakes, markers, and panels. The “User Manual” button 131 displays a training manual on the privilege user's screen. For other embodiments, the navigation bar may be arranged with any other hot buttons 44 as necessary to access other protective areas provided to the computer 2.

It is to be appreciated that access to these protected pages allows the privilege user to customize the information presented by the application 4 on the browser 12 or 20 to a user. Accordingly, a system administrator and not the user will have access to those above-mentioned protected pages. A more detailed discussion of the abovementioned protected pages follows hereafter.

Services Administration

FIG. 8 shows a form page, identified as a “Current Services” page 140. From the “Current Services” page 140, funeral directors can customize how their service offerings are displayed to a user of the funeral advising computer 2. Accordingly, a privileged user can access this area by clicking on the “Services” button 114 located on the toolbar 40 provided on either the home page 10 or any other page 14, such as the administrative areas access page 136. The privileged user is then prompted for a user name and a password by the password page 136 (FIG. 7). Once password authentication has take place, via a script file comparing entered information against a user password file on database 28, the privileged user is presented with the “Current Services” page 140.

In this area, the privilege user can enter all service information, such as to enter/update the general price list for listed services, and add, edit or delete services. To enter a new service, the privileged user clicks into the provided input boxes 50 and types in the name, price, service code, disposition, and description of the service. Next the privileged user signified if the service and/or package is a taxable item by clicking the “Tax:” radio button 56, and from a drop down box 142 selects one of the provided service type options, such as package, service, facility/transportation, merchandise, and the likes. It is to be appreciated that the service code is a unique product code, which is used for tracking purposes. The disposition field is used to instruct the computer 2 where to place the service in either the burial services page, the cremation services page, or both. Once this is completed, the privileged user clicks on an “Add Service” button 144 and the new service will be added to a list file displayed in a file list box 146 provided on the current services page 140. It is to be appreciated that the file list box 146 is another feature provided on a form page of the present invention to display and customize information contained in the files 33 that are store on local drive 18.

Clicking on the desired service listed in the file list box 146, then clicking on an “Edit Services” button 148 edits the services. A privilege user after making the desired modifications, then clicking on a “Save All Services” button 150, which updates the services list file, which is one of the files 33 stored on local drive 18. Clicking on the desired service in the file list box 146, then clicking on a “Delete Service” button 152 allows a privilege user toll remove the selected service from the list displayed. Once all modifications have been made to the file list, the privilege user clicks on a “Save all Services” button 154 to save the file list to the database 28.

Products Administration

The maintenance of products offered by the computer 2 to users during the funeral arrangement process will now be discussed with references made to FIGS. 9a-9d. To access the product administration area, a privilege user clicks on the “Products” button 116 on the toolbar 40 provided on a HTML page of site 16. After passing through the password page 136 (FIG. 7), the privileged user is displayed a products search page 155 depicted by FIG. 9a. The product search page 155 allows the user to search for specific product types or to go directly to any of the products stored in the database 28. To view a product selection for a product type or category, the user selects the product from a product selection field box 157, and if further refinement is needed, the metal type of the product may be selected from a metal type selection field 159, along with a price range selected via conditional notation fields 161.

After clicking on the search button 163, the user will be presented with a “Products Selection” page 156 as depicted, for example, by FIG. 9b, which lists all the products in the database 28 that meets the search criteria entered on the search page 155. Although the illustrated “Product Selection” page 156 is for metal caskets, it is to be appreciated that for the other products typically contained in the database 28, such as for example, wooden caskets, urns, keepsakes, markers, urn accessories, flowers, embroidered panels, vaults, and the like, a similar “Production Selection” page having the features discussed hereafter would be displayed.

From the illustrated “Products Selection” page 156, the privilege user adds, deletes, and edits the products contained in the database 28, and selects what products and pricing are shown to a user. Additionally, the privilege user may select when and where such products are presented to the user by the computer 2 during the arrangement process. By clicking on the radio buttons 56, an unflagged condition 58 will change to a flagged condition 60, such that all products with a flagged condition 60 may be displayable to a user during the funeral arrangement process. This option permits the privilege user to conveniently unlist products due to changes in inventory and/or suppliers. Additionally, while the privilege user is on page 156 a picture 66 for any of the listed products may be viewed by clicking on a product 164 or corresponding product code 166. It is to be appreciated that the update file 31 (FIG. 1) from the distributor's system 32 provides the products 164 contained in the database 28 with their associated information (name, picture, material type, and product code).

As further illustrated, information regarding each of the listed products may be modified by the privilege user on the page such as the retail price, the gender, and the disposition of the product. To enter in a desired retail price in retail column 165 for each product listed in the products column 164, the privilege user enters into the appropriate “Retail” input box 50 a desired retail price. Based on the entered retail values, the computer 2 will automatically calculate and return a “Markup” ratio 168 and a “Margin” value 170 for each product listed in the products column 164.

From the product selection page 156, clicking on a disposition field 161 instructs the computer 2 where in what part of the funeral arrangement process that selected product should appear to the user, such as for example, in the standard (STD) burial arrangement path, the cremation (CRE) arrangement path or both (S/C). The gender of the product, such as Feminine (F), Masculine (M), Natural (N) or any combination thereof, can be designated by selecting the appropriate gender from a gender field 162. To designate a particular product to be displayed as a “Most Popular” unit to a user in a products selection room HTML page (not shown), the privilege user clicks on the radio button 56 in the “Pop” column 172 for that desired product. Additionally, for each product an “Others” field 171 may be used to customize the manner in which certain types of products are displayed. For example, the “Others” field 171 could be used to select those products that will be competitive with the selections of a competitors store, or it could be used to designate which products are actually present in the funeral home.

A “Feature” field 173 can be selected to indicate a special feature of the product, such as oversized caskets, and will only be displayed if a “Features” button is selected on the page a user is viewing. Clicking on a “Rename Product” button 174 permits the privilege user to enter a name by which to represent the product on its associated selection page, if so desired.

In the case of products not carried by the centralized supplier, and/or information regarding certain products are not provided in the inventory updates, the computer 2 has the flexibility to customize and populate the database 28 with such products. This is accomplished by the computer 2 presenting to the privilege user on the “Product Selection” page 156 additional feature buttons, indicated generally by 179, which permits the privilege user to add, edit, and recommend such products. By clicking on either the add or edit button of the additional features buttons 179, the privilege user will be presented with an input page by which to add or edit products not provided in the suppliers inventory update, as illustrated by FIG. 9c. As shown the privilege user may enter or edit the product code, the manufacturer and product name, product material, wholesale and retail prices, its description, and the digital image for the product.

By clicking on the recommend button of the additional feature buttons 179, the privilege user has the ability to recommend and/or tie the added products to those products carried by the centralized supplier, such as for example recommending Urn vaults for three different suppliers, in order of preference, as illustrated by FIG. 9d. Accordingly, the privilege user has the ability to present a wider range of products to users than those products carried by the centralized supplier in order to provide an even more enriched funeral process to users.

Once all modifications have been made on the products inventory page 156, the privilege user clicks on a “Save Selection” button 175 to save the products inventory file to the database 28. If desired, the privilege user may return to the search page 155, via clicking on Search button 177, or navigate to another page via the toolbar 40.

Customer Database

FIGS. 10a, 10b, and 10c are illustrations of HTML summary pages that display information from customer records. It is to be appreciated that Funeral Directors can access the transaction history of any prior clients that they have entered into the computer 2. A “Customers” database file is part of the database 28 on local drive 18, which keeps summary information of all services and products offered by a funeral provider. The “Customers” database file can be accessed in one embodiment from the home page 10 or from any other page 14 in another embodiment, such as the administrative areas access page, by clicking on the “Customers” button 118 on the toolbar 40. After the login process, all customer names will appear on a first customer summary page 176 (FIG. 10a). The privilege user can either scroll up or down the list, or click on the corresponding letter hot spot 178 that represents the first letter of the client's last name to get an alphabetical listing 179 of last name, first name and customer ID number of all current customers.

To display a particular customer's information record 180 the privilege user clicks on the name in the alphabetical listing 179 and a script file will run that accesses the information from the customer file stored on the database 28, and returns the customer's information record 180 as is illustrated by FIG. 10b. From this page, the privilege user can convert pre-need registrations in the customer database file to at-need product orders. To convert a pre-need registration to an at-need order, the privilege user opens the customer information record 180, and if it is a pre-need record, a “Change-to-At-Need” button 181 will be displayed on toolbar 40. The privilege user clicks the “Change to At-Need” button 181, and then clicks “Yes” when the “Confirm Change” pop-up box appears (not shown) to complete the update from pre-need to at-need. This conversion process may also be initiated from the bibliographic page (FIG. 3a) by clicking on the provided “Change to At-Need” button 181.

After clicking the “Confirm Change” button 181, the privilege user or the user from the biographic page (FIG. 3a) will be presented with a pre-need to at-need page 185 (FIG. 10c). The pre-need to at-need page 185 provides the tools to update the selected pre-need products and services to at-need products and services. The update of the listed products and/or service is completed by clicking on the appropriate update button 187. To update the services and products, the privilege user or user clicks on the appropriate update button 187, which takes the privilege user or user to a selection guide, where the selection process is explained. After all the services/products have been updated, the computer 2 will redirect the privilege user or user back to the pre-need to at-need page 185 so that a comparison may be made between the pre-need services/products and the at-need services/products. Clicking on a save button (not shown) saves any changes made to the customer's record. To delete the customer for the database 28, the privilege user clicks on the “Delete Customer” button 183 on toolbar 40, which runs a script that removes the record from the database 28.

Director Reports

Clicking on the Director Reports button 130 from the navigation bar 40 of the administrative areas access page 136, after the login process, will open a HTML page 133 (FIG. 11a) that lists a number of reports that the computer 2 may run. Such reports include for example, service/product price lists, detail reports of services/product sold, number of arrangement types, and deceased and informant name and address reports. It is to be appreciated that funeral homes are required by the Federal Trade Commission to provide price lists to funeral consumers during the funeral arrangement conference. The computer 2 with the Director Reports page 133 makes it easy for funeral directors to print out price lists corresponding to the products and services that the funeral home provides.

To print out a particular price list, as illustrated by FIG. 11b, the privilege user when on this page simply clicks on one of the report buttons 135 for the desired report. A pop-up box 137 will appear on the page that will allow the user to enter a desired date range or price range for the report. After submitting the desire range of the report, a price list 139 will then generate for review as illustrated by FIG. 11b. If the privilege user is satisfied with the displayed information, selecting a print button 141 will open a =printing window 143, which allows the privilege user to print the price list on an attached printer (not shown) of the computer 2.

Site Setup

FIGS. 12a, 12b, 12c, 12d, 12e, 12f, 12g, 12h, and 12i illustrate form pages which the privilege user accesses to setup the computer 2. FIG. 12a illustrates a “Funeral Home Setup” HTML page 194 that is used to input all of a funeral home's initializing data into the computer 2 for proper operation of the application 4, as well as, for customizing the appearance of home page 10. To access the Funeral Home Setup page, a privilege user clicks on the “Setup” button 122 on the toolbar 40 either from the home page 10 or from any other page 14 that such a button is provided such as, for example, the administration area access page 136. It is to be appreciated that without setup information, the home page 10 (FIGS. 1 and 2) is blank except for the toolbar 40. After clicking on the “Setup” button 122, the user will be prompted to enter a user name and a password on the administrative areas access page 136 (FIG. 7).

After entering the proper user name and password information, clicking on the “Log In” button 138 will take the user to the “Funeral Home Setup” page 194. The user then populates the application 4 with the necessary information by typing the data into the provided input boxes 50. Any of the setup text boxes 50 that have an “*” next to them must be filled in with the proper information in order for the application 4 to work properly. The “Display Total Prices” category has a pop-up box 196 that instructs the application 4 whether or not to display in the summary information box 78 service and total funeral cost information when viewing products on a product selection information page 62 (FIG. 5c). If “No” is selected in the pop-up box 196, then only the retail product price will be displayed on the product selection information page.

Additionally provided on the setup page 194 are computer FTP access information input boxes 198. These input boxes 198 enable the application 4 to communicate with the distributors system 32 via an FTP session. Image file selection boxes 199 permit a use to locate and select an image to be displayed on the home page as the background, and conveniently turn it on or off for display. Further depicted on the setup page 194 is “Contract Information” input box 200 which the privilege user clicks into and types or “cut and pasted” from other Microsoft® based documents the desired information. Once all changes have been made to the setup page 194, the privilege user then clicks on the “Save Setup” button 202 on the toolbar 40, which saves the setup to one of the files 33 stored on the local drive 18. A discussion on the tax setup process now follows.

Tax Setup

On the home page setup page 194, a display tax selection box 197 permits a user to select either “no” or “yes” to display taxes with the price of items (service or products). By selecting “yes”, the computer 2 will calculate the tax and include it in the retail price shown to the customer. If “no” is selected, the tax will not be included in the produce or service information screens, but will be calculated in on the summary page.

The State and Local tax rates can be entered for a funeral home's location by selecting the “Tax setup” button 132 (FIG. 7a), which after the login process, takes the user to a tax information form page 201 such as, for example, as is illustrated by FIG. 12b. On the illustrated tax information form page 201, the user may enter state and local tax rates 203 and/or exemptions 205 and exemption types 207 for each of the products and services offered. A discussion on the setup of directors available for coordinating the funeral arrangement now follows.

Director Setup

By selecting a “Directors” button 126 from the navigation bar 40 on the funeral home setup page 194, a directors page 211 is provided which permits the user to setup director information 213 regarding each director using the computer 2. From the director page 211, illustrated by FIG. 12c, current directors are listed, which may be selected for deleting or editing. New director names may be added to the list by inputting the necessary information in the provided input fields and selecting the “add” button 215. A discussion on setup disclosure information now follows.

Disclosure Setup

By clicking on the Disclosure button 125, from the navigation bar of the Administration page 136, after the login process, the privilege user is taken to a disclosure form page 217 on which disclosure information may be entered, as is illustrated by FIG. 12d. On the disclosure form page 217, the privilege user fills in specific disclosure and disclaimer of warranties information certain types of products and services. Additionally, the effective date of those warranties may also be entered, and any other information required by State and Federal law. A discussion on the pre-need setup now follows.

Pre-need Setup

By clicking on the Pre-Need button 134 from the navigation bar 40, after the login process, the privilege user is taken to a “Pre-Need selection” form page 219, as illustrated by FIG. 12e. From the pre-need selection page 219, the privilege user is requested to select which insurance company's information packages 221, if any, to show to users in the service selection under pre-need. Such pre-need insurance company's information packages 221 that may be included and offered as part of the funeral arrangement process by the computer 2 includes, for example, Fortis Family and Homesteaders. A discussion on the customizing guide setup now follows.

Customizing Guide Setup

By clicking on the Customized Guides button 127 from the navigation bar 40 on the administration page 136, after the login process, the privilege user is presented with a selection guide question customization page 223 as illustrated by FIG. 12f. From similar such page 223, the use may edit the default questions 225 presented in the cremation arrangement path, the burial arrangement path, the urn arrangement path, and the services selection pages. Additionally, on other similar customization pages 223 available from the administration page 136, the user has the ability to adjust the order of the burial arrangement path and the cremation arrangement path as is illustrated, for example, for the burial arrangement path in FIG. 12g. Furthermore, the user may select what fields are visible on the Biographical Information page (FIG. 3a), change the text of the introduction page (FIG. 4a), and select which personal expressions themes that are to be displayed and/or add text and additional theme rooms. Moreover, from this area the user has the ability to add flower information and customize the appearance with text and images to the flower information pages 520 (FIG. 19a). Marker information may also be added and customizes with text and/or images to the marker pages (FIG. 4e). A discussion on shipping address maintenance will now follow.

Shipping Address Maintenance

By clicking on the on the “Shipping Addresses” button 124 from the navigation bar 40 on the administration page 136, after the login process, the privilege user is presented with a “Shipping Addresses” page 206 as illustrated by FIG. 12h. The shipping address page is used to input shipping addresses for funeral homes that have multiple locations. To add a new shipping address, the user fills in the location information (name, address, city, state, zip code, Internet address, e-mail) into the provided input boxes 50. All input boxes 50 that have an “*” next to them are required fields. Once information has been added, the user clicks on an “Add Address” button 208 provided on page 206, which runs a script saving the data to a shipping address file, one of the files 33, stored on the local drive 18.

To edit an existing address, the user selects a location 209 from a location list box 210 provided on page 206 by clicking on the location 209 to be edited so that it is highlighted. The user then clicks on an “Edit Address” button 212, which retrieves the information from the shipping address file. The user after making the desired changes, then clicks on the “Save All Addresses” button 214 on the toolbar 40, which runs a script that saves the entered information in the shipping address file. To delete an address, the user selects the location 209 to be deleted from the location list box 210, so that the location is highlighted, and then clicks on a “Delete Address” button 216. Clicking the “delete Address” button 216 runs a script that removes the highlighted location 209 from the shipping location file. A discussion on the cash advance process will now follow.

Cash Advance

FIG. 13 illustrates a form page, entitled “Current Cash Advances,” from which Funeral Directors may classify items that vary in price daily as cash advance items. The family advisor computer 2 allows Funeral Directors to customize their cash advance items 182 contained in one of the files 33 (FIG. 1). To access the cash advance maintenance area, click on the “Cash Advances” button 120 on the toolbar 40 of an HTML page on site 16. After entering a proper password on password page 136, the privilege user is displayed the “Current Cash Advances” form page 182. Page 182 allows the privilege user to input cash advance items 184 by clicking in the “Cash Advance:” input box 50 and typing in the name of the cash advance item. Once the cash advance item 184 is completed, the user clicks on an “Add Item” button 186 and that cash advance item 184 will be added to the cash advance list file.

To edit an existing cash advance item 184, the privilege user simply clicks on the desired cash advance item 184 shown in the file display box 146 so that it is highlighted, and then clicks on the “Edit Item” button 188. To save the changes, the user clicks on a “Save All Items” button 190 on the navigation toolbar 40, which runs a script that saves the changes to the cash advance list to the database 28. Lastly, to delete a cash advance item 184, the user clicks on that item listed in the list box 146 so that it is highlighted, and then clicks on a “Delete Item” button 192 to run a script that removes the item from the cash advance list. A discussion on order/update will now follow.

Order/Update

FIGS. 14a and 14b, illustrate the HTML pages use by the application 4 to review and edit product-ordering information for a customer before being sent to the distributor's system 32 via an FTP session. FIG. 14a depicts an order/update page 218 that lists in a select customer column 220 customers, and their corresponding products ordered listed in a product column 222. To access the page the user clicks on the Order/Update button 108 from the toolbar 40 on any HTML page on the site 16. It is to be appreciated that the order/update page 218 lists only those customer's orders that have not been previously uploaded to the distributor's system 32. Accordingly, multiple customers may be shown in the order/update list provided on the order/update page 218. To upload the order to the distributor's system 32, the user clicks the upload orders button 224, which runs a script that opens a FTP session with the distributor's system and transfers the product order file, one of the files 33. To review an order listed on Order/Update page 218, the privilege user clicks on a customer name 228 listed in the select customer column 220, which takes the user to an order/update form page illustrated by FIG. 14b.

FIG. 14b depicts an order/update form page 230, which enables a privilege user to review a specific customer's order, to specify delivery information, to add any special instructions to the distributor, and to place the order on-line. As depicted, provided are input boxes 50 in which to edit and enter information. Additionally, shown are the shipping addresses 209 provided in a drop down box in which to select. It is to be appreciated that the default shipping address 209 is the address provided at the top of the list in the shipping address list box 210 (FIG. 13). Further from the order/update form page 230, the privilege user can determine if the shipment is either a normal or a priority order by selecting the priority from a priority deliver drop down box 232. If at any point during the review, the privilege user wishes to go back to the original selections for the order, clicking on a reset button 234 will reset all information back to their previous selections. After the privilege user has reviewed the order and made the necessary changes, the product order is sent to the distributor's system 32 by clicking on a submit orders button 236. A discussion on the inventory update function will now follow.

Inventory Update

The “Inventory Update” function 128 of the computer 2 is used when a funeral director is about to do an at-need arrangement with a family while utilizing the computer 2. The inventory update button 128 may be selected from either home page 10 (FIG. 2a) in one embodiment, or on any other page that the button may be provided such as, for example, the administrative areas access page 136 (FIG. 7a). Selecting the inventory update button 128 causes that computer 2 to perform an online inventory check, via a FTP session, with the centralized supplier's/distributor's system 32 (FIG. 1). Performing the online inventory check will adjust available product-offerings so that a user of the funeral process computer 2 will be unable to view any out of stock items. For an individual requiring an at-need arrangement, clicking on the “Inventory Update” button 128 on the toolbar 40, when presented on the HTML page, will cause the computer 2 to automatically dial into the distributor's inventory system 32 and download an update inventory file 31. The privilege user views the file transfer from a FTP session window (not shown). Once the update inventory file 31 is downloaded into the computer 2, the application 4 will update the current inventory display listing accordingly. The privilege user will then be returned to the currently viewed page after the FTP session is completed, such that user may continue with the funeral arrangement process. A discussion on the funeral arrangement process will now follow.

Funeral Arrangement Process

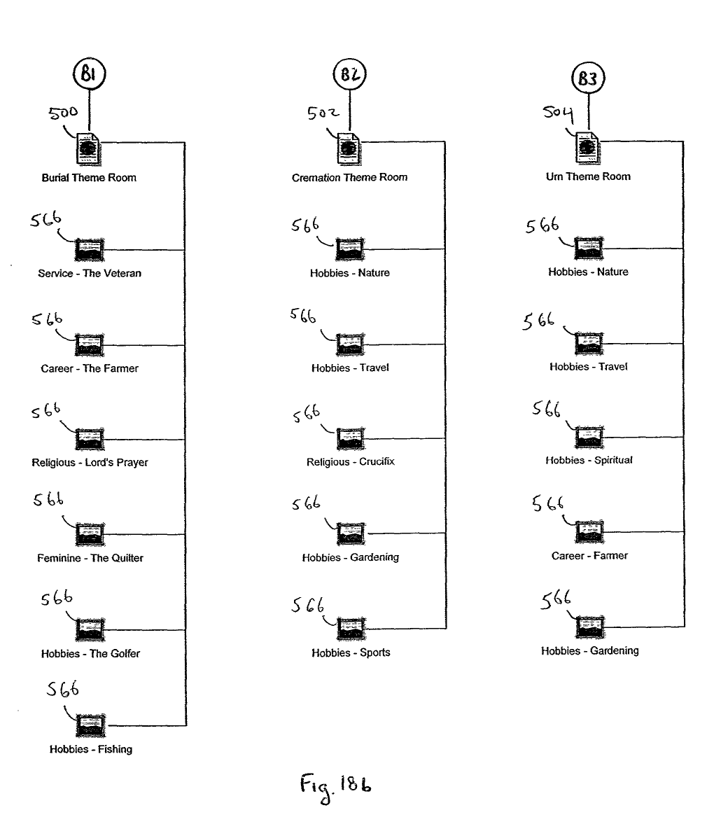

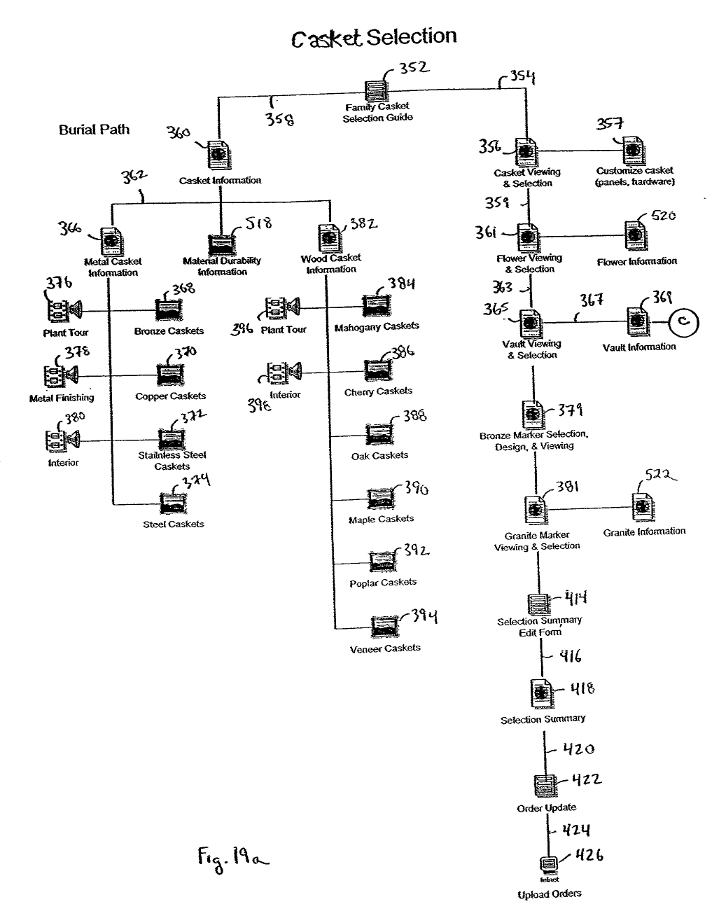

Referring to FIGS. 15-17, illustrated is a first embodiment of the present invention that takes a family through a funeral arrangement process. It is to be appreciated that flowcharts 300, 302, 304 are visual representations of the present embodiment of the structure of site 16 (FIG. 1), showing how elements of the site 16 of the application 4 are link or relate to one another.

From the home page 10 (step 306) of the family advising application 4, a user desiring to arrange for a funeral clicks on the selection room hot button 112 on the navigation toolbar 40, which takes the user to an Introduction information page 308 on site 16 of the application 4. The Introduction information page 308 gives a brief explanation of the process that a user is about to go through in making a funeral arrangement. From here the user will navigate (Step 310) to a linked biographical form page 312, where the user can select the name of a prior customer or input a new name, ID number, date, and classify the call as “At Need” or “Pre Need” (step 314). Once the information is entered, the user will click on the continue button 48 on the toolbar 40 (step 316).

The next page to appear is the Family Services Selection Guide form page 318. On page 318 the user is prompted to complete a number of questions 50 (by selecting radio buttons 54) about the type of funeral service the family is planning to have. This page 318 also includes information buttons 70 that provide more in depth information on the available funeral services (optional step 320) by being linked to a Disposition information page 322, a Cremation information page 324, and a Services information page 326. As illustrated, the Services information page 326 contains digital video clips 328, 330, 332, 334 that explain the benefits of the different types of services. Any number videos clips on different subjects and in multiple languages may be provided. Preferably, these digital video clips include a Viewing video 328, a Funeral Ceremony video 330, a Memorial Service video 332, and a Graveside Service video 334. It is to be appreciated that the above-mentioned videos show benefits to a family for each particular service as explained by a grief counselor and which are viewable if the user desires (optional step 336).

From the Family Service Selection Guide form page 318, the user selects (step 338) between a Burial option and a Cremation option. Selecting either the burial path 340 or the cremation path 342 will take the user through the same services pages 344 through 350. Once either the burial path 340 or cremation page 342 has been selected, the user may click on the provided continue button 48 to proceed to the service package page 344 for the desired service.

In going down the service path, the first page that the user will see is a packages page form 344. The packages form page 334 provides the user with choices 54 for various service packages, which is customizable by each individual funeral home. To view detailed description of any listed choices, the user can click on the text of that choice. To select the choice the user clicks on the radio button 56 next to the corresponding choice. To move to the next services form page 346 the user clicks on the “Continue” button 48 on the provided navigation toolbar 40. The user follows the same procedure of selecting choices 56 on the Services form page 346, on the Facility & Transportation form page 248, and on the Merchandise form page 250. Once all services have been selected, if on the Family Service Selection Guide form page 318 the option selected was for the burial path 340 then the user will go to a Family Casket Selection Guide form page 252. However, if the option selected was for the cremation path 342, then the user will go to a Family Cremation Casket from Guide 236.

For a burial, on the Family Casket Selection Guide form page 352 the user selects casket preferences to filter down the range of products for display. Additionally from page 352, the user can select (optional step 358) to view the Casket information page 360. From page 360, the user can view information, and make further investigations by selecting a Metal Casket information button (not shown) to go down a metal information path 362 and on a Wood Casket information button (not shown) to go down a wood casket path 364.

By clicking the metal casket path 362, the user goes to a Metal Casket information page 366. Page 366 has optional hot buttons that can be selected for additional information pages on Bronze Caskets 368, Copper Caskets 370, Stainless Steel Caskets 372, and Steel Caskets 374. In addition, digital video clips may be viewed from this page 366 on a Metal Casket Manufacturing Process 376, a Hand Brushing Process 378, and an Interior Finishing Process 380.

By selecting the wood casket information path 364, the user goes to a Wood Casket information page 382. From page 382, the user can optionally select to view other information pages containing information on mahogany caskets 384, cherry caskets 386, oak caskets 388, maple caskets 390, poplar caskets 392, and veneer caskets 394. Digital video clips may also be viewed, if desired, from this page 382 concerning a wood finish process 396 and an interior finishing process 398.

After selecting the preferences from a list of desired choices 54 (step 354), a script on the Family Casket Selection Guide form page 352 instructs the search of the products database 28 for those caskets that meet the user defined casket criteria. At completion of the query, the application 4 displays the retrieved product information, one product at a time on a HTML product selection information page 356, in order of the most expensive to the least expensive product. The product information displayed includes a digital image of the product along with the product name, a retail price, a price of services selected, total cost of the funeral incurred so far, and a counter (not shown) that indicates the total number of products that meet that user selected preferences. To see a close up of the product the user may click on the product image, which zooms in on the displayed product image.

Both the Cremation Casket Selection Guide form page 354 and the Cremation Urn Selection Guide form page 356 operate in similar fashion to the Family Casket Selection Guide form page 352. If a cremation casket is selected (optional step 400), then the user will go to a View and Select Cremation Casket information page 402, with an optional detailed information page 404 that is navigated to by a provided hot button. In either of the cases, if the Family Cremation Casket selection page is skipped (optional step 406) or not skip, the user will then be presented with the Cremation Urns Selection Guide page 356. From this page 356, the user selects urn product preferences, which then leads (step 408), via a script that performs a query on the database 28, to an Urns Selection information page 410. The urns fitting the entered preferences are displayed one at a time in order of most expensive too least expensive for viewing and selection. From this page 410, if desired a user may select to cremation urn information page 412 from which a user may images and a view a video clip that provides additional information on the manufacturing of the urns.

It is to be appreciated that from both the Casket Selection information page 356 and the Urns Selection information page 410, clicking on the provided Choose selection button 76 for each product displayed orders the product. After ordering the products, clicking on the provided Save & Continue button (step 412) will bring the user to an editable Summary page 414, which is the same ending page for both the burial and cremation paths. On this page 414, pricing adjustments can be made, as well as, editing of cash advance services. Once the statement is finalized, the user clicks on the provided Save & Continue button on the toolbar 40 (step 416) to view a condensed printable summary description page 418 of all selected services and products.

To order the products on-line the user clicks on the provided “Order/Update” button (step 420) on the toolbar 40 of the selection summary description page 418. The user is then taken to the Order Update page 422, which lists the outstanding orders that have not been previously upload to the distributor's system 32. On this page 422, the user can edit the information as discussed above in the Update/Order section. Once all order information is complete, the user clicks on the “Submit Orders” button (step 424), which starts the FTP session and transmits the order to the distributor system 32 for further processing.

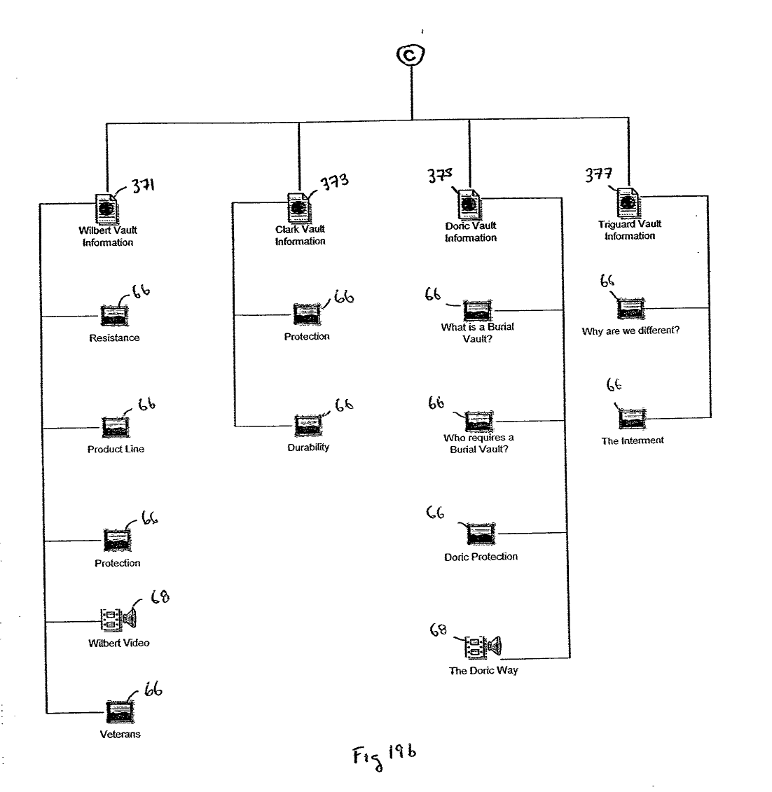

Referring to FIGS. 18-22, illustrated is another embodiment of the present invention providing additional features to the funeral arrangement process. Since many of the steps and pages are similar to the previously explained embodiment illustrated in FIGS. 15-17, only a discussion on the differences is provided.

Referring to FIGS. 18a and 18b, as with the previous embodiment, from the home page 10 (step 306) the user arranges for a funeral by clicking on the selection room hot button 112 on the navigation toolbar 40. In this embodiment the introduction information page 308, is presented to the user after entering and/or selecting customer name on the biographical information form page 312. After entering the necessary information and viewing the introduction information, the user is prompted to complete the questions 50 about the type of funeral service the family is planning to have on the family service selection guide page 318. As before, this page 318 also includes information buttons 70 that provide more in depth information on the available funeral services (optional step 320) by being linked to the Disposition information page 322, the Cremation information page 324, and the Services information page 326.

In this embodiment, the first additional feature is a personal expression information page 321, such as illustrated by FIG. 5a. The personal expression information page 321 is linked from the family services selection guide page 318, and may be viewed by clicking on the theme room button 45 from the navigation bar 40 provided thereon. If navigating to the personal expression information page 321 in optional step 319, clicking on one of the provided virtual selection room images 66, such as for example, a burial theme room, a cremation them room, and urn theme room, will present the user with a respective theme room information page.

As illustrated in FIG. 18b, a burial theme room information page 500, a cremation theme room information page 502, and an urn theme room information pages 506 presents to the user a number of theme room images 566 such as, for example, service, career, religion, feminine, and hobbies, from which to generate ideas. Clicking on any one of the displayed theme room images 566 will present to the user an enlarged image view.

The second additional feature is being able to view pre-need information. If a user desires to read the information regard pre-need, clicking on the pre-need button 45 from the selection guide page (optional step 321), as is illustrated by FIG. 3b, will present the user with a pre-need information page 323. From this page, the user may select and/or read further information about the available pre-need services on additional pre-need information pages 325, and 327 respectively. The remainder of the family service selection process continues at point A indicated in FIG. 15, and presents essentially the same features as exampled above after point A. Accordingly, for brevity no further discussion is provided regard the family services selection process in this alternative embodiment.

Turn now to FIGS. 19a and 19b, illustrated is an alternative embodiment for the family casket selection guide process. Since may of the features of the illustrated alternative embodiment are essentially the same as with the previous casket selection guide process embodiment explained above, for brevity, only a discussion on the differences is provided. One difference in this embodiment is that from the casket information page 360, the user may view material durability information on a material durability information page 518. Another difference in this embodiment is that on the casket viewing and selection page 356, if the casket is customizable, the user will be able to link to a casket's customization page 357. On the casket's customization page 357, the user will be able to view and select customizable features, such as, for example, panels, molding, and hardware.

After the casket viewing and selection page 356, the user in step 359 is directed to a flower page 361 from which flower arrangements may be viewed and selected. From the flower page 361, the user may link to additional flower information page 520 in which the user will be able to view enlarged images of flower arrangements and find out additional information. In step 363, the user is then directed to a vault page 365 from which the user may view and select vaults. If additional information regarding vaults is needed, then in optional step 367 the user may proceed to a vault information page 369 that is accessed by clicking a vault information hot button provided on a vault page 365.

As illustrated in FIG. 19b, from the vault information page 369, the user has a number of informational choices from which to choose. Such information includes, for example, information pages for Wilbert, Clark, Doric, and Triguard vaults, 371, 373, 375, and 377, respectively. From each of these information pages 371, 373, 375, and 377 the user is presented with additionally graphic/image files and/or videos explaining their respective products. Such informational page may include text, images/graphics that discuss the role of a vault, the resistance and protection afforded by the vault, when a burial vault is required, and the product line.

Turning back to FIG. 19a, after viewing and selecting a vault on the vault page 365, if desire and/or if required, the user is then presented with HTML pages for bronze markers and then granite markers, 379, and 381, respectively. On the bronze and granite marker pages 379 and 381, the user may views and selects from a number of marker selections. Additionally, the user may enter the inscription that is to be placed on the selected marker. In particular, for bronze markers the user is also able to select between a single marker, a companion marker or a veteran marker. Additionally the user may decide on an emblem for the marker, the long or short date, and whether or not to have a vase. On the marker pages, the retail price is also presented so that the user may make the appropriate decision. Additional from the granite mark page 381, a user may link to a granite information page 522 if additional detailed information is desired. After viewing these pages and/or entering the necessary information, the user is then presented with the selection summary edit form page 414, and from this point on, the casket selection process provides the same features as discussed in the previous embodiment. Accordingly, for brevity, no further discussion is provided.

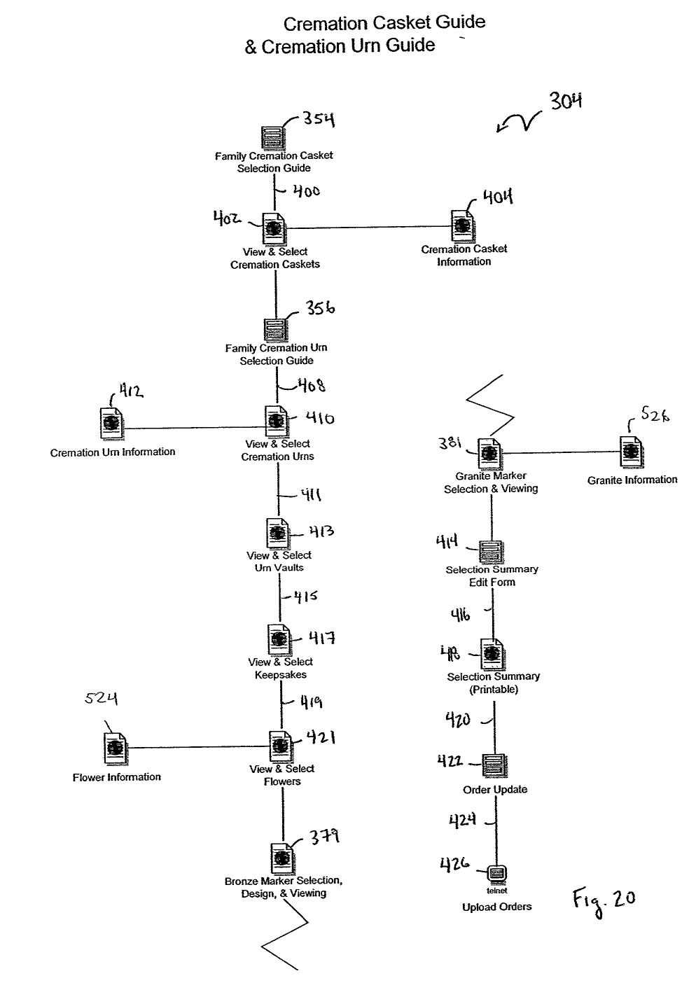

FIG. 20 illustrates an alternative embodiment of the Cremation Casket/Urn Selection Guide processes, in which additional features to the previously discussed embodiment are added. Since this embodiment has many of the same steps and pages the previously discussed embodiment, for brevity only the differences are discussed. As illustrated, after the user has viewed and selected a cremation urn on the cremation urns page 410 the user is then directed (step 411) to a urn vault page 413. On the urn vault page 413, the user may view and choose from the available vault materials. After viewing and/or choosing a vault material, the user will be presented (step 415) with a keepsake page 417. On the keepsake page 417, the user may view and select from the available keepsake products. Additionally, on this page, the user may personalize a selected keepsake, if available, by entering inscription information. The retail price for the personalization option will be provided, in addition to the retail price for the keepsake product so that the user may make the appropriate decision.

After viewing and/or selection a keepsake on the keepsake page 417, the user will be presented in step 419 a flower page 421. On the flower page 421, the user may view and select from a number of available flower arrangements and from which the user may link to a flower information page 524 providing additional details about the arrangements. The retail price will be presented on the flower page 421 so that the user may make the appropriate decision. After viewing and/or selection a flower arrangement(s), the user is presented in step 423 with bronze and/or granite marker selections page 379 and 381. The marker selection pages 379 and 381 provide essential the same features as in the casket selection process (FIG. 19a), expect for permitting the user to link to a granite information page 526 for more detailed information, and as such no further discussion is provided. Additionally, from this point on, the cremation casket/urn guide process is the same as the previously discussed embodiment and as such, no further discussion is provided.

Having described the present invention in detail and by reference to various embodiments thereof, it will be apparent that certain modifications and variations are possible without departing from the scope of the invention defined in the appended claims.

What is claimed is:

1. A computerized method for arranging a funeral, the method comprising:
presenting an electronic selection guide page which lists a plurality of selectable user actions for arranging said funeral; and
displaying a first electronic response page in response to selection of one of said plurality of user actions; said electronic response page displaying information in at least one theme to stimulate ideas for personalizing said funeral.

2. The method according to claim 1 wherein a second electronic response page displayed in response to selection of another one of said plurality of user actions provides information contained in a database on available funeral services and products and enables a selection of said funeral services and products.

3. The method according to claim 1 further comprising:
compiling from a database a summary list of desired funeral services and products for said funeral in response to another selected user action; and
providing said summary list.

4. The method according to claim 2 further comprising:
customizing said information regarding said funeral services contained in said database by:
displaying a current services page in response to a selected user action for services from said electronic selection guide page and populating said current services page with existing funeral service information from said database;
customizing said funeral service information on said current service page; and
updating said database with said customized funeral service information.

5. The method according to claim 2 further comprising the steps of:
customizing said information regarding funeral products contained in said database by:
displaying a funeral products information page in response to selected user action for products from said electronic selection guide page and populating said funeral products information page with existing funeral products information from said database;
customizing said funeral products information on said funeral products information page; and
updating said database with said customized funeral product information.

6. The method according to claim 2 further comprising populating said database with said information from a remote server.

7. The method according to claim 6, further comprising:
updating said information by:
downloading from said remote server an information update for said funeral services and products in response to a user selection from said selectable options page regarding inventory update; and
updating said database with said information update.

8. A method according to claim 3 further comprising:
ordering said desired funeral services and products from a distributor by:
forwarding an items list generated from said summary list to a database server of said distributor for processing delivery of said desired funeral services and products in response to a user action for ordering said desired funeral services and products.

9. A method according to claim 3 wherein said providing said summary list includes the step of displaying said summary list with a further user selectable option of printing said summary list.

10. The method according to claim 1 further comprising of the step of:
displaying a multimedia presentation corresponding to a particular aspect of a funeral arrangement process in response to a user action for selecting said multimedia presentation.

11. The method of according to claim 10 wherein displaying said multimedia presentation includes the step of showing a video clip, displaying text, and playing a sound file.

12. The method according to claim 8, further comprising:
compiling and sending an e-mail message from said server database of said distributor to said database, said e-mail message containing confirmation of said products ordered and expected delivery dates.

13. A computer-readable medium whose contents cause a computer to have a memory device store information related to funeral products and service, and to have a display terminal display information related to funeral services and products, and enable said computer to guide a user through the planning of a funeral.

14. The computer-readable medium as recited in claim 13 further causing said computer to access data stored in said memory device and store data to said memory device.

15. The computer-readable medium as recited in claim 14 further causing said computer to enable an input device to enter information in said memory device and to select visual objects display on the display terminal.

16. The computer-readable medium as recited in claim 15, further causing said computer to enable a communication device to connect to a remote server database of a distributor of funeral products to update said data stored in said memory device and to provide funeral arrangement data to said server database.

17. A computer system for assisting a user in making funeral arrangements, said computer system comprising:
a display terminal; and
a memory device storing information related to funeral products and service, wherein said computer is running an application that displays said information related to funeral services and products on said display terminal and guides the user through the planning of a funeral.

18. The computer system as recited in claim 17 wherein said application further causes said computer to access data stored in said memory device and store data to said memory device.

19. The computer system as recited in claim 17 wherein said application further causes said computer to enable an input device to enter information in said memory device and to select visual objects display on the display terminal.

20. The computer system as recited in claim 17 wherein said application further causes said computer to enable a communication device to connect to a remote server database containing additional information regarding said funeral services and products to update said data stored in said memory device and to provide user selected funeral arrangement data to said remote server database.
